(19) United States
(12) Patent Application Publication
(10) Pub. No.: US 2026/0346610 A1
(43) Pub. Date: Nov. 5, 2026

(54) LIQUID EJECTION HEAD

(71) Applicant: CANON KABUSHIKI KAISHA, Tokyo (JP)

(72) Inventors: AYAKO MARUYAMA, Kanagawa (JP); YOSHIYUKI NAKAGAWA, Kanagawa (JP); TAMAKI SATO, Kanagawa (JP); KAZUHISA OKANO, Tokyo (JP)

(21) Appl. No.: 19/664,238

(22) Filed: Apr. 30, 2026

(30) Foreign Application Priority Data
May 1, 2025 (JP) 2025-076411
Feb. 13, 2026 (JP) 2026-022312

(51) Int. Cl. B41J 2/17; B41J 2/14; B41J 2/175

(52) U.S. Cl. CPC B41J 2/1707; B41J 2/14201; B41J 2/1433; B41J 2/17563; B41J 2002/14419

(57) ABSTRACT

In a liquid ejection head including: a first substrate including a plurality of pressure chambers, a first common supply channel, and a first common collecting channel; a second substrate laminated on the first substrate and including a second common supply channel, a second common collecting channel, and recessed portions provided in regions facing the first common supply channel and the first common collecting channel; and a flexible film provided between the first and the second substrates and having a supply opening that connects the first and the second common supply channels, a collection opening that connects the first and the second common collecting channels, and a film portion that covers the recessed portions of the second substrate to form damper chambers, an opening area of the collection opening perpendicular to the first direction is larger than the opening area of the ejection port perpendicular to the first direction.

### BACKGROUND

### Field of the Technology

The present disclosure relates to a liquid ejection head that ejects a liquid such as ink, and an image forming apparatus including the same.

### Description of the Related Art

In recent years, there has been an increasing demand for higher image quality in liquid ejection heads such as inkjet recording heads, and it has been required to arrange nozzles densely to increase the resolution. In some liquid ejection heads, ink is supplied from a common channel to pressure chambers of respective elements via individual channels. Pressure fluctuations occurring in a pressure chamber when droplets are ejected from the nozzle of each element propagate to the pressure chamber of another nozzle via the common channel, thereby altering ejection characteristics and causing a problem of crosstalk. Crosstalk causes variations in ejection speed and ejection volume, thereby deteriorating image performance. As one means of suppressing crosstalk, a method of providing a damper structure (FDI (Filter Damper Intermediate)) in order to suppress pressure fluctuations in the common channel is known (Japanese Patent Application Laid-Open No. 2023-152239). This is a structure in which a flexible film is sandwiched between a plurality of laminated substrates constituting the liquid ejection head, and a portion of the flexible film covers a recessed portion provided in a substrate to form a damper chamber.

The flexible film includes, in addition to a portion that functions as a damper film of the damper chamber, a portion that is laminated between the substrates so as to block the liquid channels. The latter portion may be provided with an opening to allow liquid to pass therethrough, or may be provided with minute holes serving as a filter. By performing such cutting or hole-forming processing, the flexible film, which is a single film, comes to have holes in various locations, resulting in a state in which various stresses are generated in the remaining portions. As a result, stresses generated at partition wall portions of the damper structure that fix the damper film increase, and there is a possibility that the damper film may become prone to peeling. In addition, if small holes serving as a filter are formed in the damper film on the liquid collecting side, there is a possibility that ink circulation may be impeded, such as by an increase in pressure loss in ink circulation making it impossible to supply sufficient ink, or by debris mixed in from the nozzle surface causing clogging.

### SUMMARY

The present disclosure is directed to provide a technology capable of achieving stabilization of liquid circulation and stabilization of a damper structure.

According to an aspect of the present disclosure, a liquid ejection head of the present disclosure includes:
a first substrate including a plurality of pressure chambers, a first common supply channel, and a first common collecting channel, the plurality of pressure chambers each being provided with an ejection port that opens in a first direction and a pressure generating unit for generating pressure to eject liquid from the ejection port, the first common supply channel being a channel for supplying liquid to each of the plurality of pressure chambers, the first common collecting channel being a channel for collecting liquid from each of the plurality of pressure chambers;
a second substrate laminated on the first substrate in the first direction, the second substrate including a second common supply channel, a second common collecting channel, and a recessed portion, the second common supply channel being a channel for supplying liquid to the first common supply channel, the second common collecting channel being a channel for collecting liquid from the first common collecting channel, the recessed portion being recessed in the first direction and provided in each of a region facing the first common supply channel and a region facing the first common collecting channel; and
a flexible film provided between the first substrate and the second substrate, the flexible film having a supply opening, a collection opening, and a film portion, the supply opening being an opening that penetrates the flexible film in the first direction and causes the first common supply channel and the second common supply channel to communicate with each other, the collection opening being an opening that penetrates the flexible film in the first direction and causes the first common collecting channel and the second common collecting channel to communicate with each other, the film portion covering the recessed portion to form a damper chamber,
wherein an opening area of the collection opening perpendicular to the first direction is larger than an opening area of the ejection port.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of an inkjet recording apparatus.

FIG. 2A is a schematic perspective view of a liquid ejection head 1.

FIG. 2B is a view of a liquid ejection substrate as seen from a nozzle surface.

FIG. 2C is a view of the liquid ejection substrate as seen from a side opposite to the nozzle surface.

FIG. 3A is a cross-sectional view taken along line A-A of the liquid ejection substrate in FIG. 2B.

FIG. 3B is an enlarged view of the vicinity of the ejection port in FIG. 3A.

FIG. 4 is a plan view of Example 1 of the present disclosure.

FIG. 5A is a cross-sectional view taken along line B-B of FIG. 4 in Example 1 of the present disclosure.

FIG. 5B is a cross-sectional view taken along line C-C of FIG. 4 in Example 1 of the present disclosure.

FIG. 6A is a cross-sectional view taken along line D-D of FIG. 4 in Example 1 of the present disclosure.

FIG. 6B is a cross-sectional view taken along line E-E of FIG. 4 in Example 1 of the present disclosure.

FIG. 7 is a plan view of Example 1 of the present disclosure.

FIG. 8A is a cross-sectional view taken along line F-F of FIG. 7 in Example 1 of the present disclosure.

FIG. 8B is a cross-sectional view taken along line G-G of FIG. 7 in Example 1 of the present disclosure.

FIG. 9A is a plan perspective view showing an enlarged partial view of a liquid ejection substrate 2 of Example 2 of the present disclosure.

FIG. 9B is a cross-sectional view taken along line H-H of FIG. 9A.

FIG. 10A is a plan perspective view showing an enlarged partial view of the liquid ejection substrate 2 as another example of Example 2 of the present disclosure.

FIG. 10B is a cross-sectional view taken along line I-I of FIG. 10A.

FIG. 11 is a plan view of Example 3 of the present disclosure.

FIG. 12A is a cross-sectional view taken along line J-J of FIG. 11 in Example 3 of the present disclosure.

FIG. 12B is a cross-sectional view taken along line K-K of FIG. 11 in Example 3 of the present disclosure.

FIG. 13 is a plan view of Example 4 of the present disclosure.

FIG. 14A is a cross-sectional view taken along line L-L of FIG. 13 in Example 4 of the present disclosure.

FIG. 14B is a cross-sectional view taken along line M-M of FIG. 13 in Example 4 of the present disclosure.

FIG. 15 is a plan view of Example 4 of the present disclosure.

FIG. 16A is a cross-sectional view taken along line N-N of FIG. 15 in Example 4 of the present disclosure.

FIG. 16B is a cross-sectional view taken along line O-O of FIG. 15 in Example 4 of the present disclosure.

FIG. 17 is a perspective view of Example 4 of the present disclosure.

FIG. 18 is a cross-sectional view of Example 4 of the present disclosure.

FIG. 19 shows calculation results of Example 4 of the present disclosure.

FIG. 20 is a plan view of Example 5 of the present disclosure.

FIG. 21A is a cross-sectional view taken along line B2-B2 of FIG. 20 in Example 5 of the present disclosure.

FIG. 21B is a cross-sectional view taken along line C2-C2 of FIG. 20 in Example 5 of the present disclosure.

FIG. 21C is a cross-sectional view taken along line D2-D2 of FIG. 20 in Example 5 of the present disclosure.

FIG. 22A is a cross-sectional view showing an enlargement of FIG. 21A in Example 5 of the present disclosure with the nozzle substrate and actuator substrate omitted.

FIG. 22B is a cross-sectional view showing an enlargement of an end portion of FIG. 21C in Example 5 of the present disclosure with the nozzle substrate and actuator substrate omitted.

FIG. 23 is a graph showing a relationship between an opening ratio of common film openings and pressure loss.

FIG. 24 is a plan view of Example 7 of the present disclosure.

FIG. 25A is an enlarged plan view of a region 1001 in FIG. 24 of Example 7 of the present disclosure.

FIG. 25B is a diagram showing a comparative example of Example 7.

FIG. 26A is a cross-sectional view taken along line M2-M2 of FIG. 25A in Example 7 of the present disclosure.

FIG. 26B is a cross-sectional view taken along line L2-L2 of FIG. 25A in Example 7 of the present disclosure.

FIG. 27 is a plan view of Example 8 of the present disclosure.

FIG. 28 is an enlarged plan view of Example 8 of the present disclosure.

FIG. 29A is a cross-sectional view of a comparative example with respect to Example 8 of the present disclosure.

FIG. 29B is a cross-sectional view taken along line P2-P2 of FIG. 28 in Example 8 of the present disclosure.

FIG. 29C is a cross-sectional view taken along line Q2-Q2 of FIG. 28 in Example 8 of the present disclosure.

### DESCRIPTION OF THE EMBODIMENTS

Hereinafter, embodiments for implementing this technology will be described in detail by way of example on the basis of examples, with reference to the drawings. However, it is to be understood that dimensions, materials, shapes, relative arrangements, and the like of components described in the embodiments should be changed as appropriate in accordance with configurations and various conditions of apparatuses to which the present disclosure is to be applied. That is, the scope of this technology is not intended to be limited to the following embodiments.

In each of the following embodiments, an inkjet recording head and an inkjet recording apparatus that eject ink will be described as examples with specific configurations thereof; however, the apparatuses to which the present disclosure is applicable are not limited thereto. The liquid ejection head, liquid ejection apparatus, and liquid supply method of the present disclosure are applicable to apparatuses such as printers, copiers, facsimile machines having communication systems, word processors having printer units, and further to industrial recording apparatuses used in complex combination with various processing apparatuses. For example, these may also be used for applications such as bio-chip fabrication and electronic circuit printing.

The liquid for recording that is ejected by the liquid ejection head according to the embodiments of the present disclosure toward a recording medium is typically ink, but may also include, for example, a liquid used for processing ink (e.g., a liquid for coagulating or insolubilizing a colorant in ink applied to a recording medium). Recording is not limited to forming significant information such as characters and figures, and is not limited to whether the information is significant or not. Furthermore, recording may broadly include forming an image, pattern, or the like on a recording medium, or processing an object to be ejected, regardless of whether the result is manifested in a form perceivable by human vision. In addition, the recording medium is typically paper, but may also include materials capable of receiving ink, such as cloth, plastic film, metal plate, glass, ceramics, wood, and leather.

### Example 1

### Description of the Overall Head

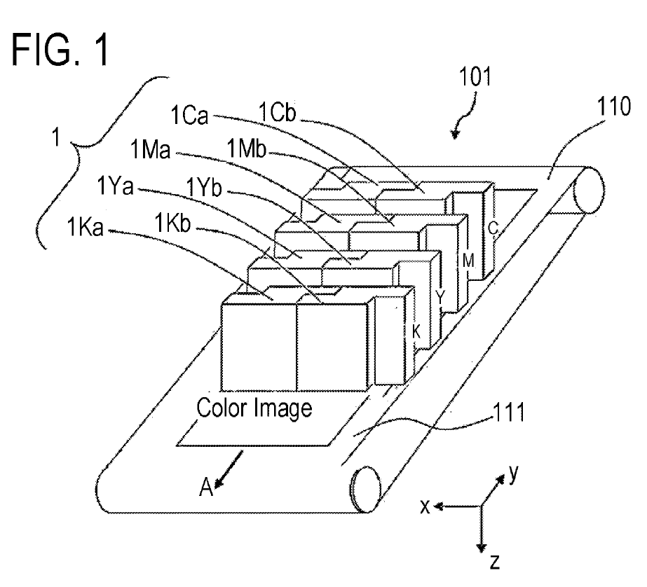

FIG. 1 illustrates a recording apparatus 101 as an example of a liquid ejection apparatus according to the present embodiment. FIG. 1 is a schematic perspective view of a recording apparatus 101 having a one-pass-type liquid ejection head module 1 (hereinafter referred to as "liquid ejection head 1") that records an image on a recording medium 111 in a single pass of the recording medium 111. In the liquid ejection head 1, ejection ports (also referred to as nozzles) are arranged across the side corresponding to the full width of the recording medium 111. The liquid ejection head 1 of the present embodiment is a head corresponding to four colors: cyan (C), magenta (M), yellow (Y), and black (K). More specifically, the liquid ejection head 1 includes liquid ejection heads 1Ca and 1Cb corresponding to cyan (C) ink, and liquid ejection heads 1Ma and 1Mb corresponding to magenta (M) ink. The liquid ejection head 1 also includes liquid ejection heads 1Ya and 1Yb corresponding to yellow (Y) ink, and liquid ejection heads 1Ka and 1Kb corresponding to black (K) ink. The recording medium 111 is conveyed in the direction of arrow A by a conveying portion 110, and recording is performed by the liquid ejection head 1. Note that the recording apparatus 101 shown in FIG. 1 is merely one example, and may be configured to be capable of mounting a liquid ejection head 1 of any form. For example, the recording apparatus 101 may have only one type of liquid ejection head, or may have many types of liquid ejection heads other than four types. That is, other forms not shown in FIG. 1 are not excluded, and the present disclosure is not limited to any particular form.

### Description of the Configuration of the Liquid Ejection Head

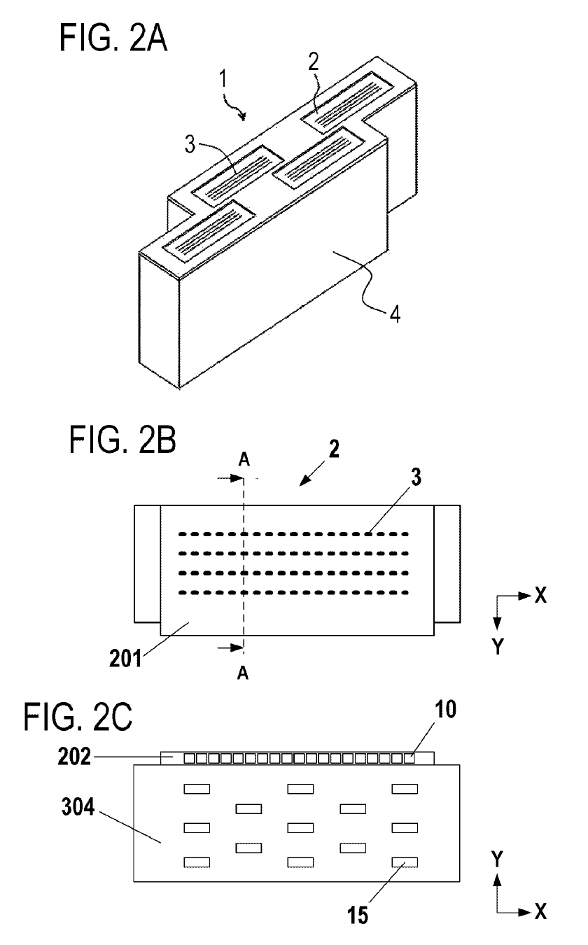

FIG. 2A is a schematic perspective view of the liquid ejection head 1 according to the present embodiment, and is a perspective view of the liquid ejection head 1 for any one color among those shown in FIG. 1. The liquid ejection head 1 has a head body 4. In the head body 4, a plurality of liquid ejection substrates 2 are arranged (in this figure, four liquid ejection substrates 2 are arranged). Each liquid ejection substrate 2 is provided with a plurality of nozzles 3 (ejection ports). Ink ejected from the liquid ejection head 1 is supplied from an ink tank (not shown) to the liquid ejection substrate 2 via a common supply port (not shown) of the head body 4. The liquid ejection substrates 2 are arranged such that end portions of the nozzles 3 arranged in the X direction overlap in the Y direction. By arranging the liquid ejection substrates 2 in this manner, recording by a long nozzle row (ejection port row) can be achieved.

FIG. 2B is a view of the liquid ejection substrate 2 as seen from the nozzle 3 surface. FIG. 2C is a view of the liquid ejection substrate 2 as seen from a side opposite to the nozzle 3 surface. The liquid ejection substrate 2 is configured using a plurality of substrates laminated in the lamination direction (Z direction, first direction). As shown in FIG. 2B, the liquid ejection substrate 2 includes a nozzle substrate 201. The nozzle substrate 201 is formed with nozzles 3 (ejection ports) that open in the lamination direction, and the plurality of nozzles 3 are arranged along the longitudinal direction (X direction, third direction) of the liquid ejection substrate 2 (nozzle substrate 201) to form a nozzle row. Further, in the nozzle substrate 201, a plurality of nozzle rows extending in the longitudinal direction of the substrate are arranged, that is, in the lateral direction (Y direction, second direction) of the substrate. As shown in FIG. 2C, a channel forming substrate 304 is provided on the surface of the liquid ejection substrate 2 opposite to the surface on which the nozzles 3 are formed. A plurality of connection channels are formed in the channel forming substrate 304. The liquid ejection head 1 of the present embodiment is configured such that ink circulates. Ink is supplied to the liquid ejection substrate 2 or liquid is recovered from the liquid ejection substrate 2 via the connection channels formed in the channel forming substrate 304. The ink supplied to the liquid ejection substrate 2 passes through channels inside the substrate, and ink is ejected from the nozzles 3 and applied to the recording medium 111. In addition, an electric substrate (not shown) for supplying power and signals necessary for ejection from the nozzles 3 is arranged in the head body 4, and is connected to the terminals 10 of the respective liquid ejection substrates 2 by wiring (not shown). Note that the examples described with reference to FIGS. 2A-2C are also merely one example of the present embodiment, and the liquid ejection head 1 can be configured in any form.

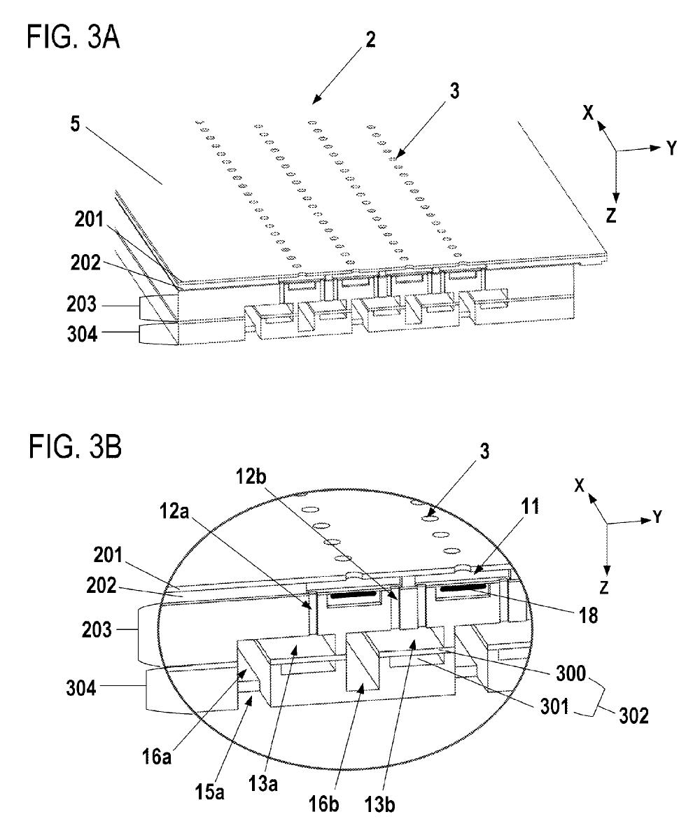

FIG. 3A is a cross-sectional view taken along line A-A in FIG. 2B. FIG. 3B is an enlarged view of the vicinity of the ejection port in FIG. 3A. As shown in FIG. 3A, the liquid ejection substrate 2 of the present embodiment is formed by a laminated structure of a plurality of substrates. Specifically, the liquid ejection substrate 2 has four substrates: a nozzle substrate (ejection port forming substrate) 201, an actuator substrate (vibration substrate) 202, a channel substrate (liquid supply substrate) 203, and a channel forming substrate 304. The liquid ejection substrate 2 is formed by bonding a flexible film 300 serving as a damper member between the channel forming substrate (second channel forming substrate) 304 and the channel substrate 203.

A more detailed description will be given with reference to FIG. 3B. Pressure chambers 11 communicating with the nozzles 3 are formed in the liquid ejection substrate 2. Each pressure chamber 11 is formed for each nozzle 3. Further, a piezoelectric element 18 is provided on each deformable wall surface formed by the actuator substrate 202 in each pressure chamber 11. The piezoelectric element 18 can pressurize the liquid in the pressure chamber 11 by deforming the actuator substrate 202, thereby causing ink to be ejected from the nozzle 3.

An individual supply channel 12a and an individual collecting channel 12b each communicating with the pressure chamber 11 are formed in the channel substrate 203 for each pressure chamber 11. Ink is supplied to the pressure chamber 11 from the individual supply channel 12a and is ejected from the nozzle 3. In addition, a part of the ink can flow from the pressure chamber 11 to the individual collecting channel 12b. The plurality of individual supply channels 12a communicate with a first common supply channel 13a formed in the channel substrate 203. The plurality of individual collecting channels 12b communicate with a first common collecting channel 13b formed in the channel substrate 203. A wall surface of the first common supply channel 13a facing the individual supply channels 12a is formed by the flexible film 300. A damper chamber 301 is provided at a position facing the individual supply channels 12a. A wall surface of the first common collecting channel 13b facing the individual collecting channels 12b is formed by the flexible film 300. A damper chamber 301 is provided at a position facing the individual collecting channels 12b. The damper chamber 301 is a region of the wall surface on which the flexible film 300 is formed, and is a region that constitutes the recessed space provided in the channel forming substrate 304. When pressure fluctuations occur, the flexible film 300 can absorb pressure using the recessed space provided in the channel forming substrate 304. The first common supply channel 13a and the first common collecting channel 13b extend in the longitudinal direction of the liquid ejection substrate 2. Further, the first common supply channel 13a and the first common collecting channel 13b are formed in plurality so as to be alternately arranged in the lateral direction of the liquid ejection substrate 2.

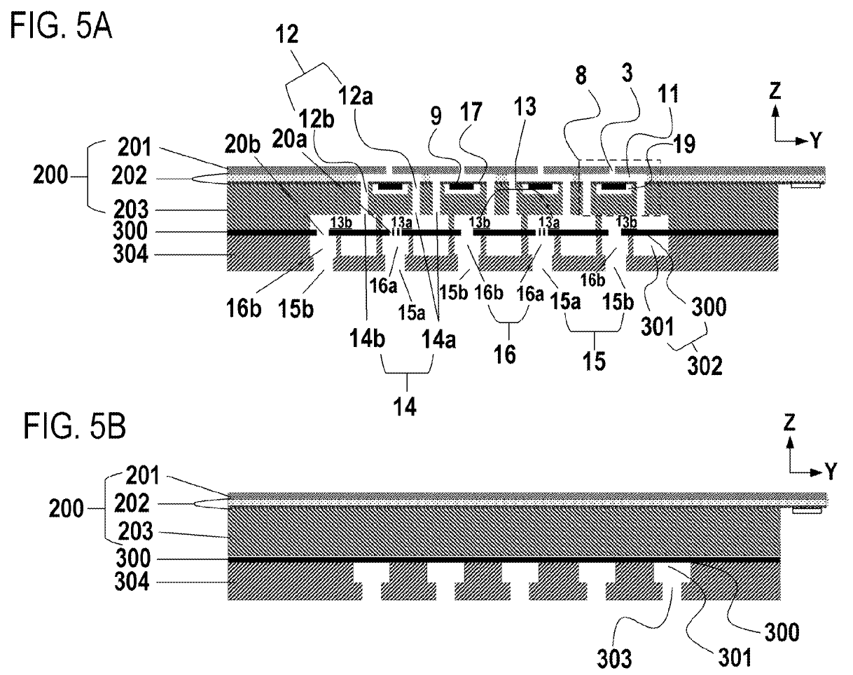

The first common supply channel 13a communicates with a second common supply channel 16a formed in the channel forming substrate 304. The second common supply channel 16ais formed with a plurality of common supply through-holes 15a. Ink is supplied from outside the liquid ejection substrate 2 via the common supply through-holes 15a. The first common collecting channel 13b communicates with a second common collecting channel 16b formed in the channel forming substrate 304. The second common collecting channel 16b is formed with a plurality of common collecting through-holes 15b (see FIG. 5A and the like). Ink is recovered to the outside of the liquid ejection substrate 2 via the common collecting through-holes 15b. The second common supply channel 16a and the second common collecting channel 16b extend in the longitudinal direction of the liquid ejection substrate 2. Further, the second common supply channel 16aand the second common collecting channel 16b are formed in plurality so as to be alternately arranged in the lateral direction of the liquid ejection substrate 2. As shown in FIG. 3, the first common supply channel 13a and the second common supply channel 16a together form a common supply channel. Similarly, the first common collecting channel 13b and the second common collecting channel 16b together form a common collecting channel.

The nozzle substrate 201, actuator substrate 202, channel substrate 203, and channel forming substrate 304 can each be formed from a silicon substrate or the like. Further, although the present embodiment has been described with an example in which each of these is a separate substrate, the present disclosure is not limited to separate substrates. The flexible film 300 is formed of an elastic member, and a resin member such as polyimide or polyamide can be used, for example. Dry etching can be mentioned as a method for forming openings in the flexible film 300. In addition, if the damper member is a photosensitive resin, patterning may be performed by exposure.

In this manner, the liquid ejection substrate 2 is formed by laminating, in order, the nozzle substrate 201, the actuator substrate 202, the channel substrate 203, the flexible film 300, and the channel forming substrate 304. The nozzle substrate 201 forming the nozzles 3, the actuator substrate 202 forming the pressure chambers 11, and the channel substrate 203 forming the individual supply channels 12a, the individual collecting channels 12b, the first common supply channel 13a, and the first common collecting channel 13b form a first channel forming substrate 200. The channel forming substrate 304 forming the second common supply channel 16a and the second common collecting channel 16b is laminated on the first channel forming substrate 200 (first substrate) with the flexible film 300 sandwiched therebetween, as a second channel forming substrate (second substrate).

Further, the channel forming substrate 304 has a first face laminated on the flexible film 300, and a second face that is the face opposite to the first face. The channel forming substrate 304 has a through-port (connection channel portion) penetrating the first face and the second face. The channel forming substrate 304 also forms a recessed portion functioning as the damper chamber 301 on the first face side. The through-port and the recessed portion are arranged alternately in the lateral direction (Y direction) of the liquid ejection substrate 2.

### Description of Nozzle Arrangement, Damper Arrangement, and Atmospheric Communication Holes

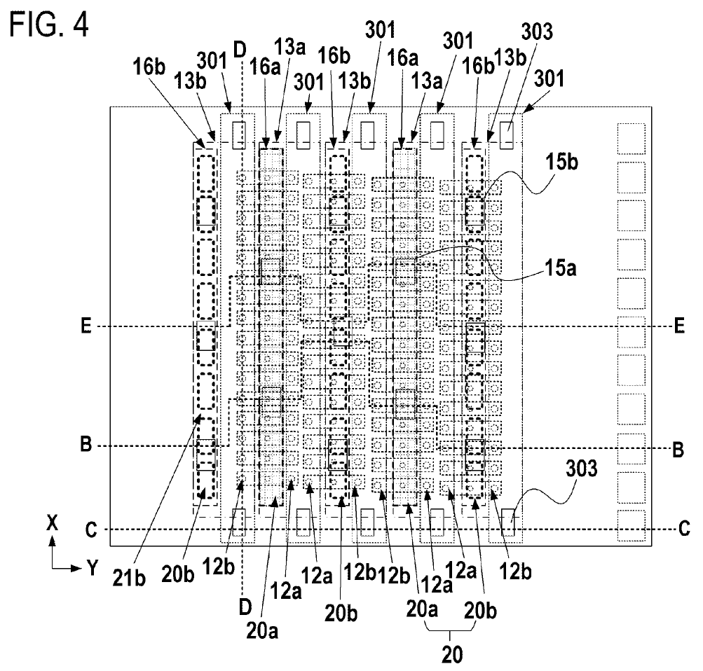

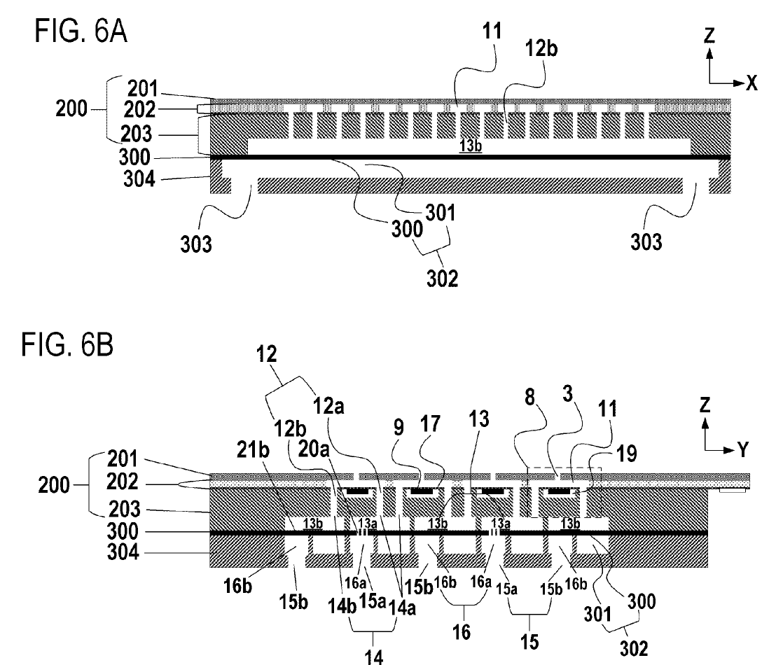

FIG. 4 is a plan perspective view showing an enlarged partial view of the liquid ejection substrate 2, FIG. 5A is a cross-sectional view taken along line B-B of FIGS. 4, 5B is a cross-sectional view taken along line C-C of FIG. 4. FIG. 6A is a cross-sectional view taken along line D-D of FIGS. 4, and 6B is a cross-sectional view taken along line E-E of FIG. 4.

A plurality of elements 8 each including a nozzle 3, a pressure chamber 11, an individual channel 12 communicating with the pressure chamber 11, and pressure generating unit 9 for generating pressure in the pressure chamber 11 are arranged in the X direction to form the liquid ejection substrate 2. The individual supply channel 12aand the individual collecting channel 12b forming the individual channel 12 of each element are each connected to a first common channel 13 consisting of the first common supply channel 13a and the first common collecting channel 13b. The first channel forming substrate 200 is composed of the nozzle substrate 201, the actuator substrate 202, and the channel substrate 203.

Connection locations of the individual supply channel 12a, the individual collecting channel 12b, the first common supply channel 13a, and the first common collecting channel 13b are individual openings 14. The individual openings 14 include individual supply openings 14a and individual collection openings 14b. On the face opposite to the face having the individual openings 14, the channel forming substrate 304 (second substrate) having the damper chambers 301, the second common channel 16, and the common through-holes 15 is arranged with the flexible film 300 sandwiched therebetween. The damper structure 302 having the damper chambers 301 is arranged at positions facing the individual openings 14. The damper chambers 301 are formed by recessed portions, which are provided in the channel forming substrate 304 in a region facing the first common supply channel 13a and in a region facing the first common collecting channel 13b and which are recessed in the lamination direction (Z direction, first direction), being covered (closed) by the flexible film 300. The recessed portion is sized to allow a film portion of the flexible film 300 covering the recessed portion to deform in response to fluctuations in pressure within the channels.

The first common channel 13, the second common channel 16, and the damper chambers 301 are formed so as to extend in a direction along the nozzle rows, and are formed on the face opposite to the nozzle surface with respect to the pressure generating unit 9 in the Z direction in which liquid is ejected.

The damper chamber 301 is open to the atmosphere by having atmospheric communication holes 303 at both ends of the damper structure 302 in the X direction. Further, by forming the damper structure 302 in each nozzle row, the elements 8 in each nozzle row can be arranged at high density. Furthermore, the damper structure 302 can have a shorter length in the Y direction by increasing the length of the nozzle row in the X direction to ensure damper performance. By being able to shorten the length of the damper structure 302 in the Y direction, the distance between nozzle rows adjacent in the Y direction can be shortened, enabling miniaturization of the liquid ejection substrate 2 and the liquid ejection head. For example, in FIG. 4, the pressure chambers 11 corresponding to the elements 8 in each nozzle row have a length in the X direction of 110 μm, and the pressure chambers and nozzles are arranged at intervals of 150 dpi. Further, by arranging four such nozzle rows offset in the X direction, a high-density nozzle arrangement of 600 dpi with respect to the recording medium can be achieved. In the present example, 600 dpi is achieved with four rows, but a configuration of 1200 dpi with eight rows may also be used.

In the flexible film 300, a common film opening 20 is formed at the connection portion between the second common channel 16 and the first common channel 13 to enable supply and collection of liquid.

As shown in FIGS. 4 and 5A, a common supply film opening 20a (supply opening) is formed at the connection portion between the second common supply channel 16a and the first common supply channel 13a. The common supply film opening 20a (supply opening) penetrates the flexible film 300 in the lamination direction (Z direction, first direction) and causes the second common supply channel 16a and the first common supply channel 13a to communicate with each other. Further, a common collection film opening 20b (collection opening) is formed at the connection portion between the second common collect channel 16b and the first common collecting channel 13b. The common collection film opening 20b (collection opening) penetrates the flexible film 300 in the lamination direction (Z direction, first direction) and causes the second common collecting channel 16b and the first common collecting channel 13b to communicate with each other.

As shown in FIG. 5A, the common supply film opening 20a is an opening provided with a filter function by forming a large number of holes having opening areas smaller than the opening area of the nozzle 3. That is, the common supply film opening 20ais composed of a plurality of communication holes each having the same opening area, which is smaller than the opening area of the nozzle 3 as measured perpendicular to the lamination direction (Z direction, first direction). On the other hand, the common collection film opening 20b is an opening having a diameter larger than the opening diameter of the nozzle 3. That is, the opening area of the common collection film opening 20b perpendicular to the lamination direction (Z direction, first direction) is larger than the opening area of the nozzle 3.

As shown in FIG. 6B, the common collecting bridge 21b in which the common collection film opening 20b is not formed, exists with the flexible film 300 partially covering the second common collecting channel 16b.

When liquid is supplied to the common supply through-holes 15a, the liquid passes from the second common supply channel 16a through the common supply film opening 20a, from the first common supply channel 13a through the individual supply openings 14a, through the individual supply channels 12a of the respective elements 8, and reaches the pressure chambers 11 and the nozzles 3. The liquid can further be recovered from the common collecting through-holes 15b by flowing from the individual collecting channels 12b through the individual collection openings 14b, through the first common collecting channel 13b, through the common collection film opening 20b, and through the second common collecting channel 16b.

When a differential pressure is applied to the common supply through-holes 15a and the common collecting through-holes 15b from the outside by a pump or hydrostatic pressure or the like, liquid can be circulated, and nozzle circulation can be performed by suctioning the nozzles 3 from the nozzle surface 5 while circulating the liquid to fill the insides of the nozzles with liquid.

In the increased density accompanying nozzle circulation as described above, since the respective pressure chambers 11 are in proximity and the supply and collecting channels are common in adjacent nozzle rows, pressure waves are transmitted from two types of channels to other pressure chambers 11. Therefore, crosstalk affecting ejection characteristics becomes a concern. In the present example, by arranging the damper structure 302 along the nozzle row direction, which is the X direction in the figure, it is possible to absorb pressure waves of crosstalk while achieving high-density nozzle arrangement and miniaturization of the liquid ejection head.

Pressure generated in each pressure chamber 11 is transmitted to the first common supply channel 13a and the first common collecting channel 13b via the individual supply channels 12a and the individual collecting channels 12b, thereby propagating pressure to other pressure chambers 11. Therefore, by providing the damper structure 302 at positions facing the individual supply channels 12a and the individual collecting channels 12b, pressure from the individual supply channels 12a and the individual collecting channels 12b can be absorbed before being transmitted to the first common supply channel 13a and the first common collecting channel 13b. For this reason, the second channel forming substrate 304 is formed such that the damper structures 302 and the second common supply channels 16a or the second common collecting channels 16b are alternately arranged. In the example shown in FIG. 4, the channels and damper structures are arranged in the order of the second common collecting channel 16b, the damper structure 302, the second common supply channel 16a, and the damper structure 302 from the near side in the Y direction.

There is no restriction on the opening shape, size, or arrangement position of the common film opening 20, as long as the configuration does not impede circulation of liquid. However, if an opening is made with a size equivalent to the XY-plane size of the second common channel 16, the flexible film 300 will be largely divided within the XY plane, which may lead to easy peeling. Therefore, in the present disclosure, by configuring the flexible film 300 to partially cover the second common channel 16, a configuration is achieved in which the flexible film 300 is not largely divided within the XY plane, thereby enabling suppression of peeling of the flexible film 300. In particular, the opening area of the common collection film opening 20b is larger than the opening area of the nozzle 3, since foreign matter mixed in from the nozzle 3 can be discharged to the outside of the liquid ejection head via the respective collecting channels and respective openings.

Further, as shown in FIG. 5A and the like, a plurality of holes each having an opening area smaller than the opening area of the nozzle 3 are provided in the common supply film opening 20a to provide a filter function. For the filter function, the opening may have approximately 80% of the opening area of the nozzle 3.

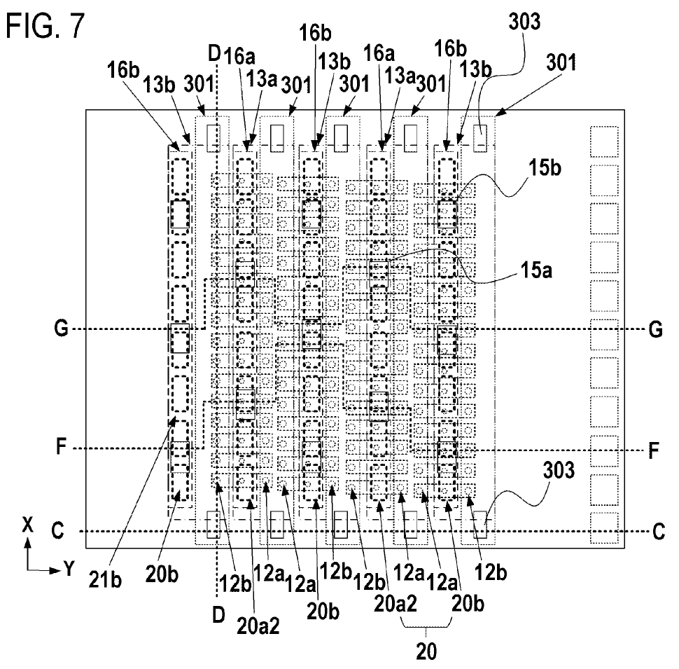

As the opening area of the nozzle 3 becomes smaller, it becomes necessary to form even smaller openings, and the pressure loss of the liquid increases. Therefore, a filter function is separately provided on the liquid supply side of the liquid ejection head or the ejection apparatus, the common supply film opening 20a is configured to have the same configuration as the common collection film opening 20b to reduce pressure loss. FIG. 7 shows one example when a separate filter function is provided on the liquid supply side of the liquid ejection head or the ejection apparatus.

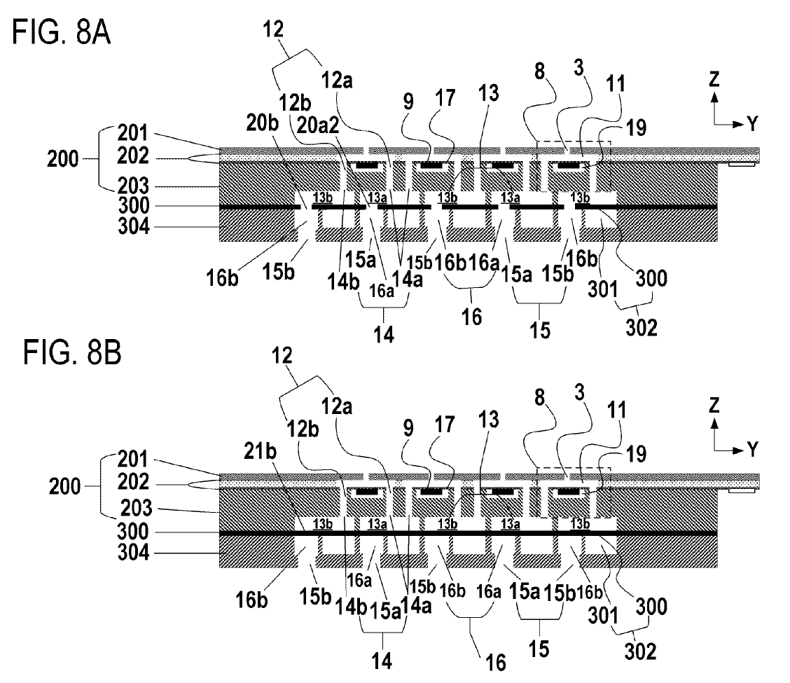

FIG. 7 is a plan perspective view showing an enlarged partial view of the liquid ejection substrate 2, FIG. 8A is a cross-sectional view taken along line F-F of FIGS. 7 and 8B is a cross-sectional view taken along line G-G of FIG. 7. The cross-sections C-C and D-D of FIG. 7 are the same as in FIG. 4. The configuration shown in FIG. 7 has the common supply film opening 20a2 with the same configuration as the common collection film opening 20b, and is a configuration in which the pressure loss of liquid is small and the flexible film 300 is resistant to peeling.

### Example 2

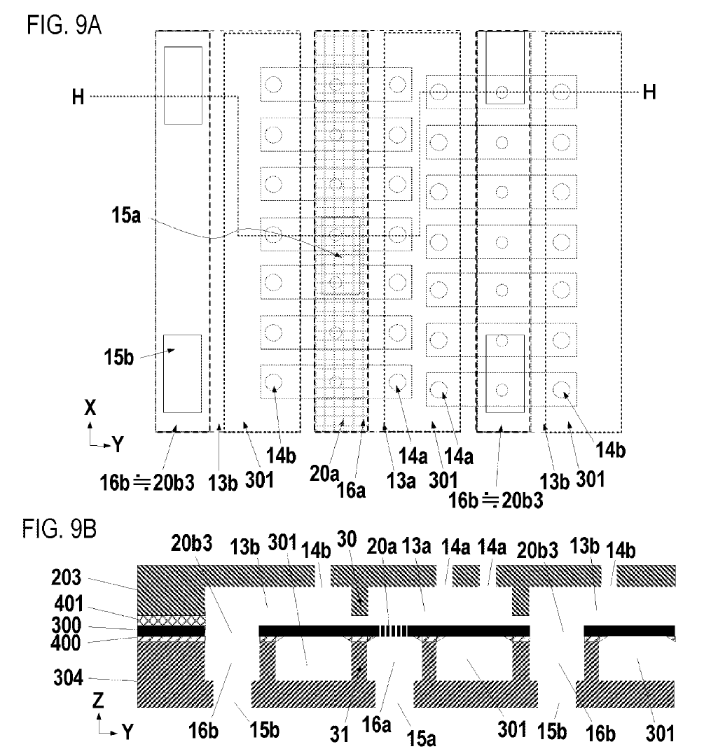

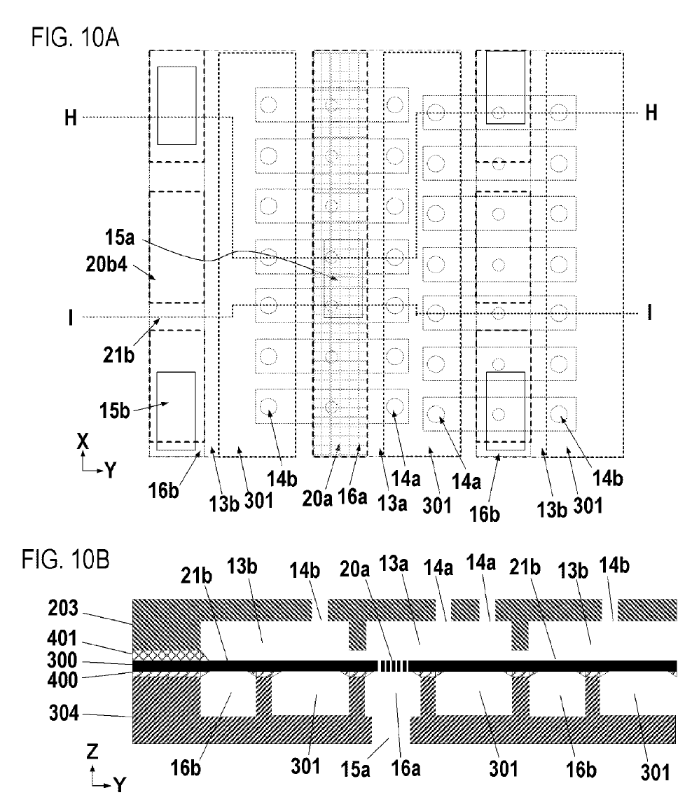

One example of a comparative example and an application example of the present disclosure will be described with reference to FIGS. 9A and 9B and FIGS. 10A and 10B. FIG. 9A is a plan perspective view showing an enlarged partial view of the liquid ejection substrate 2, and FIG. 9B is a cross-sectional view taken along line H-H of FIG. 9A. FIG. 10A is another example, and FIG. 10B is a cross-sectional view taken along line I-I of FIG. 10A. The cross-sectional views of FIGS. 9B and 10B omit a portion of the first substrate.

The flexible film 300 is fixed to the second channel forming substrate 304 with an adhesive 400. The liquid ejection substrate 2 is formed by bonding, with a mounting adhesive 401, the face of the channel substrate 203 constituting the first channel forming substrate 200 on the first common channel 13 side to the face of the flexible film 300 bonded to the second channel forming substrate 304.

As shown in FIGS. 9A and 9B and 10A and 10B, a first wall 30 separating the first common supply channel 13a and the first common collecting channel 13b formed in the channel substrate 203 is not bonded to the flexible film 300 with the mounting adhesive 401. In order to prevent the first wall 30 from being fixed at a position that hinders vibration of the damper structure 302 due to the effects of overflow of the mounting adhesive 401 and positional misalignment during bonding, the first channel forming substrate 200 and the second channel forming substrate 304 to which the flexible film 300 is fixed are bonded only at the outer periphery of the substrates. Depending on the manufacturing method of each substrate and the method of positioning the substrates during bonding, the first wall 30 and the flexible film 300 may be bonded together.

FIG. 9B is a cross-sectional view at the position where the common supply film opening 20a and the common collection film opening 20b3 are formed. The common supply film opening 20a has a configuration in which a plurality of holes each having an opening area smaller than that of the nozzle 3 are formed. On the other hand, the common collection film opening 20b3 has an opening with a size equivalent to the XY-plane size of the second common channel 16.

The opening widths in the short-side direction of the configuration shown in FIGS. 9A and 9B are 891 μm for the first common channel 13, 266 μm for the second common channel 16, 500 μm for the damper chamber 301, 226 μm for the common through-hole 15, and 266 μm for the common collection film opening 20b3. The holes of the common supply film opening 20aare arranged within a range where the holes will not be blocked even if the adhesive 400 overflows within a width of 266 μm. The diameter of the nozzle 3 is 30 μm, and holes of 27 μm are arranged at a pitch of 33 μm. The width in the short-side direction of the first wall 30 and the second wall 31 is 125 μm.

The lengths in the long-side direction (lengths in the X direction) of the configuration shown in FIGS. 9A and 9B are 27,290 μm for the first common channel 13 and 25,800 μm for the second common channel 16. The damper chamber 301 is 26,490 μm, the common through-hole 15 is 500 μm, and the common collection film opening 20b3 is 25,800 μm. The openings of the common supply film opening 20a are arranged within a range where they will not be blocked even if the adhesive 400 overflows within a length of 25,800 μm.

The depths in the Z direction of the configuration shown in FIGS. 9A and 9B are 200 μm for the first common channel 13, 425 μm for the second common channel 16, 425 μm for the damper chamber 301, 200 μm for the common through-hole 15, and 2.5 μm for the common film opening 20. The thickness of the flexible film 300 is 2.5 μm, the thickness of the adhesive 400 is 2 μm, and the thickness of the mounting adhesive 401 is 3 μm.

The first channel forming substrate 200 and the second substrate are silicon substrates, the flexible film 300 is a polyimide film, the adhesive 400 is BCB (benzocyclobutene), and the mounting adhesive 401 is an epoxy-based adhesive. Description of the sizes and materials of other components of the liquid ejection substrate 2 is omitted, as they may be set to any desired size and material as appropriate.

With such a configuration, the flexible film 300 at the portion of the common collection film opening 20b3 is in a state of being largely divided within the XY plane. In this case, the flexible film 300 is adhesively fixed only at the width of 125 μm of the second wall 31, and is structurally asymmetric on the damper chamber 301 side and the common collection film opening 20b side, and is a configuration prone to peeling due to the influence of overflow of the adhesive 400 and the physical property values of each member.

Specific physical property values are for the silicon of the second wall 31, Young's modulus is 210 GPa and linear expansion coefficient is 3×10^-6/K; and for BCB of the adhesive 400, Young's modulus is 2.9 GPa and linear expansion coefficient is 52×10^-6/K. The polyimide film of the flexible film 300 has a Young's modulus of 7.3 GPa and a linear expansion coefficient of 4.5×10^-6/K. Since the linear expansion coefficient of BCB, which fixes the polyimide film to silicon, is larger than that of other members, the polyimide film on the common collection film opening 20b3 side is in a state of being pulled toward the damper chamber 301 side, and the polyimide film tends to peel toward the damper chamber 301 side.

FIGS. 10A and 10B show a channel configuration in which the ease of peeling of the polyimide film of FIGS. 9A and 9B has been reduced. The cross-section taken along line H-H of FIG. 10A is the same as FIG. 9B, but the cross-section taken along line I-I of FIG. 10A shows a channel configuration in which a common collecting bridge 21b is provided, in which the common collection film opening 20b4 is not formed. That is, the width of the common collection film opening 20b4 (collection opening) in the short-side direction (Y direction) is equivalent to the width of the second common collecting channel 16b in the same direction, and the common collection film opening 20b4 is provided as a plurality of openings divided in the long-side direction (X direction) orthogonal to both the lamination direction and the short-side direction. The size of the common collection film opening 20b4 is an opening width in the short-side direction of 266 μm and an opening length in the long-side direction of 500 μm, arranged at a pitch of 625 μm in the long-side direction. The length of the common collecting bridge 21b in the long-side direction is 125 μm.

By providing the common collecting bridge 21b, the flexible film 300 is no longer largely divided within the XY plane, and a structurally symmetric configuration can be achieved on both the damper chamber 301 side and the common collecting bridge 21b side. This makes it possible to reduce the number of locations where the polyimide film on the common collection film opening 20b4 side is pulled toward the damper chamber 301 side, and peeling of the polyimide film can be reduced as compared with the configuration shown in FIGS. 9A and 9B. The size and arrangement position of the common collection film opening 20b4 may be set to the desired size and placed at the desired position in consideration of the pressure loss of the liquid and the like.

### Example 3

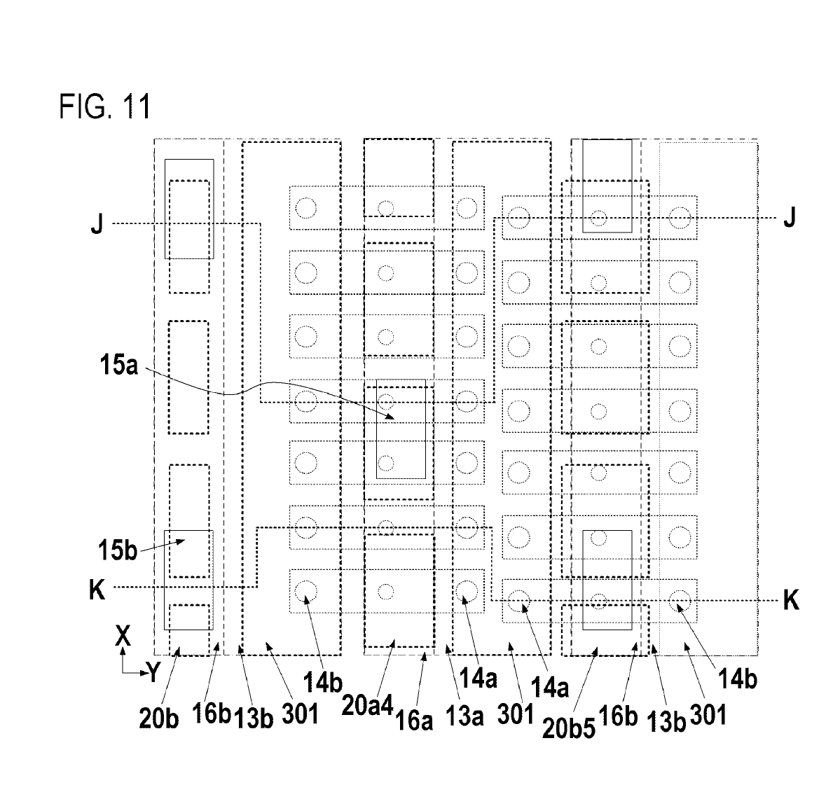

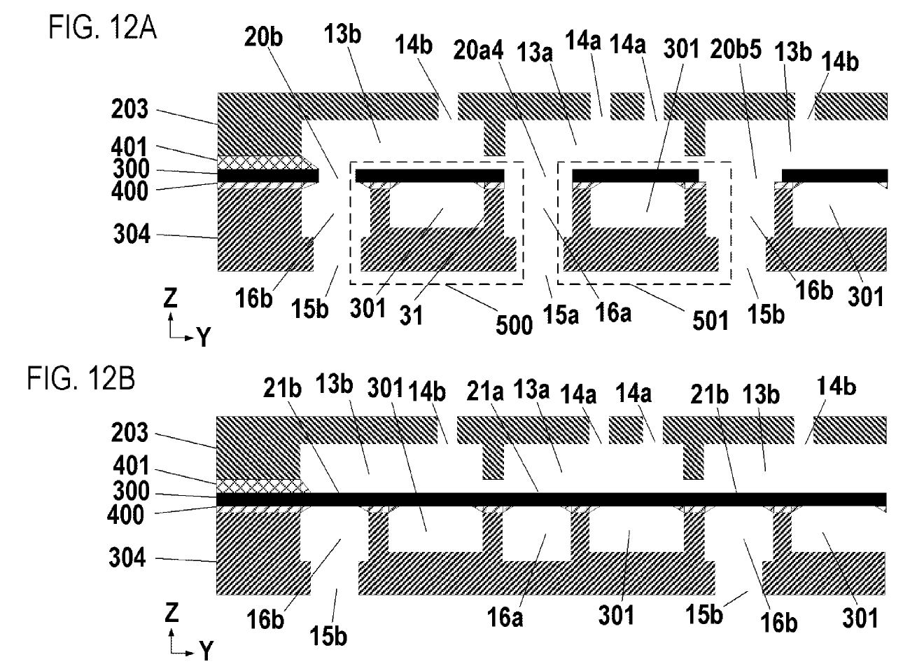

One example of the common film opening 20 and the common bridge 21 will be described with reference to FIGS. 11 and 12A and 12B. FIG. 11 shows a configuration example in which the size of the common film opening 20 differs for each second common channel 16. FIG. 12A is a cross-sectional view taken along line J-J of FIGS. 11 and 12B is a cross-sectional view taken along line K-K of FIG. 11.

The first common supply channels 13a and the first common collecting channels 13b are each provided in plurality so as to be alternately aligned with each other in the Y direction (second direction). Correspondingly, the second common supply channels 16a and the second common collecting channels 16b are also each provided in plurality so as to be alternately aligned with each other in the same direction. The common film opening 20 includes a common collection film opening 20b, a common supply film opening 20a4, and a common collection film opening 20b5. The common collection film opening 20b5 (first collection opening) causes the first common collecting channel 13b, which is adjacent to the first common supply channel 13a on one side in the Y direction, to communicate with the second common collecting channel 16b, which is adjacent to the second common supply channel 16a on one side in the same direction. The common collection film opening 20b(second collection opening) causes the first common collecting channel 13b, which is adjacent to the first common supply channel 13a on the other side in the Y direction, to communicate with the second common collecting channel 16b, which is adjacent to the second common supply channel 16a on the other side in the same direction. The width in the Y direction of the common collection film opening 20b5 (first collection opening) is wider than the width in the same direction of the second common collecting channel 16b that the common collection film opening 20b5 causes to communicate with the first common collecting channel 13b. The width in the Y direction of the common collection film opening 20b (second collection opening) is narrower than the width in the same direction of the second common collecting channel 16b that the common collection film opening 20b causes to communicate with the first common collecting channel 13b. The common collection film opening 20b (second collection opening) is arranged closer to the end portion of the flexible film 300 than the common collection film opening 20b5 (first collection opening) in the Y direction.

The opening widths in the short-side direction of the respective common film openings 20 in the configuration shown in FIG. 11 are 206 μm for the common collection film opening 20b, 226 μm for the common supply film opening 20a4, and 326 μm for the common collection film opening 20b5. The lengths of the respective common film openings 20 in the long-side direction are all 500 μm, and they are arranged at a pitch of 625 μm in the long-side direction. The lengths in the long-side direction of the common collecting bridge 21b and the common supply bridge 21a are 125 μm. The sizes of other structural members are the same as in Example 2.

The configurations of the respective common film openings 20b, 20a4, and 20b5 were locally modeled within the ranges indicated by 500 and 501 in FIG. 12A, and the normal stresses in the Z direction caused by differences in linear expansion coefficients were determined by structural calculation. The physical property values of the materials are the same as in Example 2, and the densities of the respective members are 2,340 kg/m^3 for silicon, 1,500 kg/m^3 for BCB, and 1,430 kg/m^3 for the polyimide film; and the Poisson's ratios are: 0.16 for silicon and 0.3 for BCB and the polyimide film.

When the maximum values of the normal stresses of the respective configurations were normalized and compared, the values were 0.68 for the common film opening 20b, 1.2 for the common film opening 20a4, and 2.2 for the common film opening 20b5, and it was found that the configuration with the smaller opening width in the short-side direction of the common film opening 20 has smaller stress. It was found that, as with the common bridge 21, by bringing the configuration closer to a structurally symmetric one on both the damper chamber 301 side and the common collection film opening 20b side, the force by which the polyimide film on the common collection film opening 20b side is pulled toward the damper chamber 301 side can be reduced, and peeling of the polyimide film can be suppressed. From the above, the opening width of the common film opening 20 in the short-side direction is smaller than the opening width of the second common channel 16 in the short-side direction. Further, the common collection film opening 20b has an opening area in the XY plane larger than the opening area of the nozzle 3 in preparation for the inflow of foreign matter from the nozzle 3, since foreign matter can be discharged.

Furthermore, in the present example, the width of the common collection film opening 20b is set to 206 μm, which is smaller by 30 μm on each side than the second common collecting channel 16b; however, when the width was set to 236 μm, which is smaller by 15 μm on each side, generation of debris due to overflow of the adhesive 400 was confirmed. Therefore, the opening width of each common film opening 20 is set to a size that can prevent generation of debris due to overflow of the adhesive 400. If the width of the common collection film opening 20b is made too small, the pressure loss of liquid increases and the stress balance with the damper chamber 301 side deteriorates. Therefore, the opening width of each common film opening 20 is in a range of approximately 236 μm to 141 μm, which is at least 30 μm smaller than the width of the second common collecting channel 16b and not more than the width of the second wall 31 of 125 μm. However, the opening width may be adjusted in accordance with the second common channel 16 and the width of the second wall.

Further, also at the end portions in the longitudinal direction of the second common channel 16, the common film opening 20 is smaller than the second common channel 16, since this can reduce stress in the flexible film 300, which is a polyimide film.

### Example 4

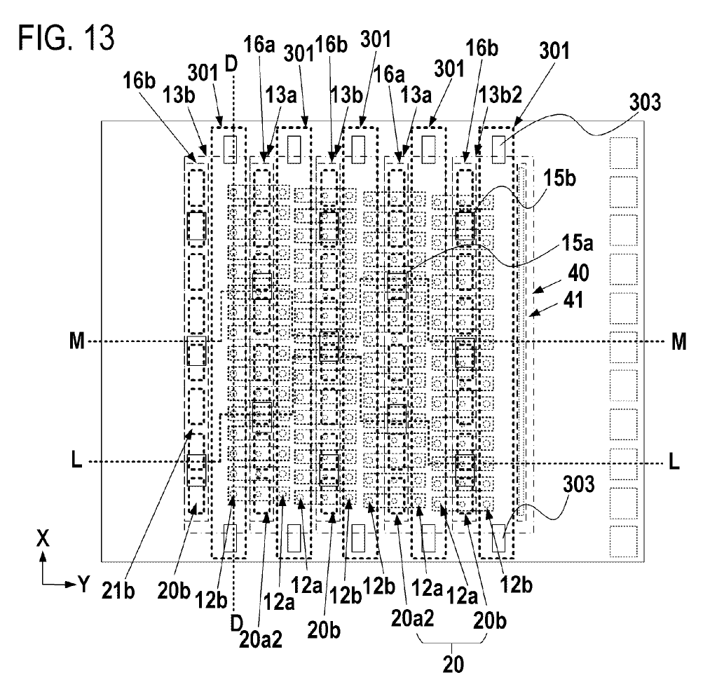

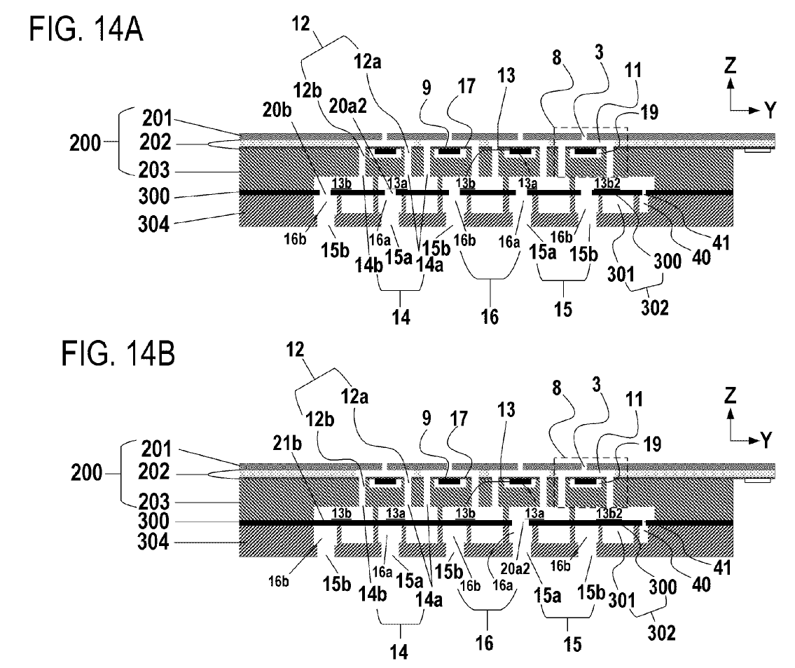

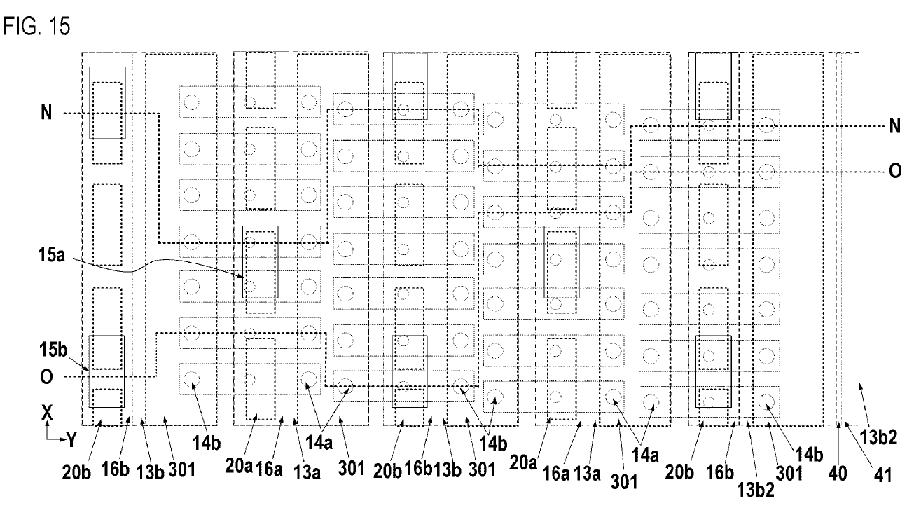

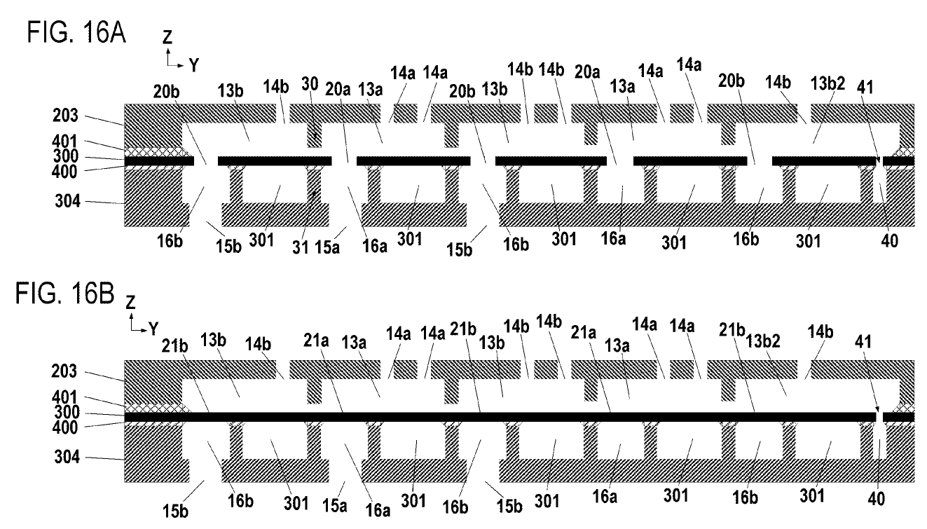

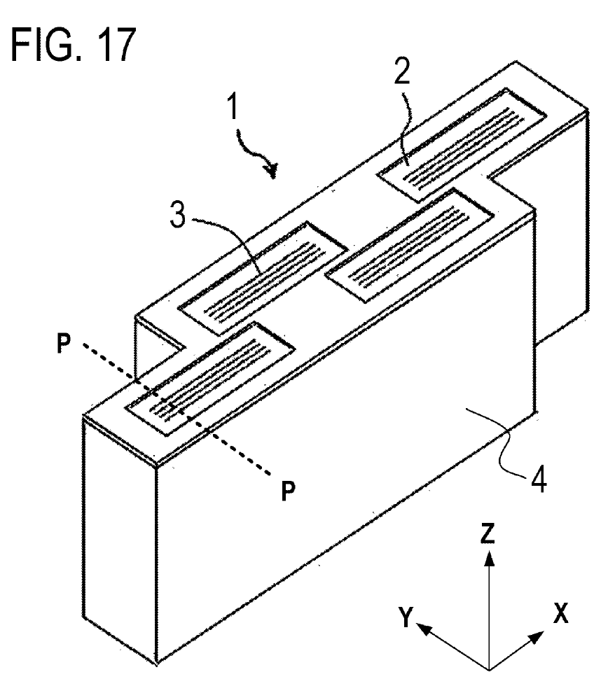

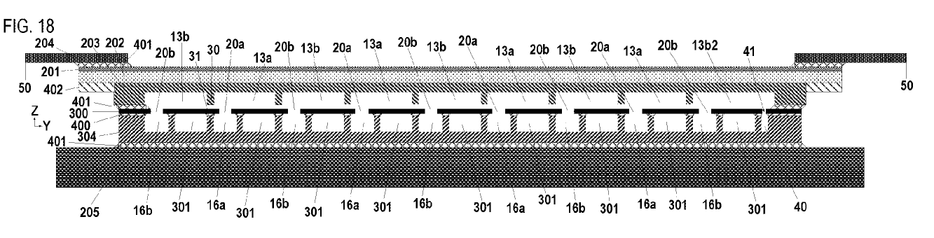

Another configuration example for reducing stress applied to the flexible film 300 will be described with reference to FIGS. 7 and 8A and 8B and 13-18. FIG. 13 shows an XY-plane view of a configuration in which a slit groove 40 and a slit opening 41 are provided in the second channel forming substrate 304. FIG. 14A is a cross-sectional view taken along line L-L of FIGS. 13 and 14B is a cross-sectional view taken along line M-M of FIG. 13. FIG. 15 is an enlarged view of a portion of FIGS. 13, 16D is a cross-sectional view taken along line N-N of FIGS. 15, and 16B is a cross-sectional view taken along line O-O of FIG. 15. The cross-sectional views of FIGS. 16A and 16B omit a portion of the first substrate. FIG. 17 shows the liquid ejection head module 1 similar to FIGS. 2, and 18 is a cross-sectional view taken along line P-P of FIG. 17, omitting a portion of the liquid ejection head module 1.

As shown in FIGS. 7 and 8A and 8B, the second common channel 16 and the damper chambers 301 formed in the second channel forming substrate 304 are arranged in the order of the second common channel 16 and the damper chamber 301 toward the Y direction, with the terminal end in the Y direction being the damper chamber 301. The flexible film 300 is fixed with an adhesive 400 or a mounting adhesive 401 so as to be sandwiched between the second channel forming substrate 304 and the first channel forming substrate 200. Therefore, with the configuration shown in FIGS. 7 and 8A and 8B, the damper structure 302 at the terminal end in the Y direction is in a different state from the other damper structures 302. Specifically, the damper structures 302 on the starting point side in the Y direction have the second common channels 16 on both sides, but the damper structure 302 on the terminal end side in the Y direction has the second common channel 16 only on the left side. Therefore, the flexible film 300 of the damper structure 302 on the terminal end side in the Y direction may be subject to increased stress due to the difference in linear expansion coefficients between the adhesive 400 or mounting adhesive 401 and the channel forming substrate 304 or channel substrate 203, and there is a possibility that peeling or tearing may occur.

Therefore, as shown in FIGS. 13 and 14A and 14B, stress applied to the flexible film 300 can be reduced by providing a slit groove 40 on the right side of the damper structure 302 at the terminal end side in the Y direction. That is, the first common supply channels 13aand the first common collecting channels 13b are each provided in plurality so as to be alternately aligned with each other in the Y direction, and on both sides in the same direction, the first common collecting channels 13b are arranged further outward than the first common supply channels 13a. The channel forming substrate 304 is provided with a slit groove 40 in a region outside the outermost damper chamber 301 on one side in the Y direction and facing the first common collecting channel 13b arranged at the outermost position on one side in the same direction. The slit groove 40 is recessed in the Z direction (first direction) and extends in the X direction (third direction). In this case, the first common collecting channel 13b2 may be opened wider in the Y direction than the slit groove 40. That is, the slit groove 40 is configured to communicate with the first common collecting channel 13b2 via the slit opening 41. If the opening width of the first common collecting channel 13b2 is narrow and the slit groove 40 is blocked, the configuration becomes different from the damper structure 302 on the starting point side in the Y direction, and the stress reduction effect of the slit groove 40 is reduced.

FIGS. 16A and 16B are diagrams showing the state of the adhesive 400 and the mounting adhesive 401 that fix the flexible film 300. An adhesive 400 such as BCB fixes the second channel forming substrate 304 and the flexible film 300 such that it overflows onto the flexible film 300. The mounting adhesive 401 also fixes the first channel forming substrate 200 and the flexible film 300 such that it overflows onto the flexible film 300. Therefore, the first common collecting channel 13b2 opens wider in the Y direction than the slit groove 40 and has a size that is not blocked by the mounting adhesive 401. Further, although an effect can be obtained even without opening the flexible film 300 above the slit groove 40, opening the flexible film 300 is opened as in the slit opening 41 since it increases the stress reduction effect. The slit opening 41 is opened with a size that will not be filled by overflow of the adhesive 400 that fixes the flexible film 300 to the second channel forming substrate 304.

In order to confirm the stress reduction effect of the slit groove 40 and the slit opening 41, a local two-dimensional model of the ZY cross-section of the liquid ejection head module 1 as shown in FIG. 17 is presented in FIG. 18. The normal stresses in the Z direction caused by differences in linear expansion coefficients were determined by structural calculation, both with and without the slit opening 41. In addition, a configuration equivalent to that shown in FIG. 18 but without the slit groove 40 was calculated as a comparative example.

The nozzle substrate 201, actuator substrate 202, and channel substrate 203 constituting the first channel forming substrate 200, as well as the second channel forming substrate 304, were silicon substrates. The flexible film 300 is a polyimide film, the adhesive 400 is BCB, and the mounting adhesive 401 is an epoxy-based adhesive.

At both ends of the first channel forming substrate 200 on the nozzle surface 5 side, face covers 204 are adhesively fixed with the mounting adhesive 401. Both ends of the actuator substrate 202 and a portion of the face covers 204 are adhesively fixed with a sealing agent 402 so as to cover electrode pads (not shown). On the face of the second channel forming substrate 304 opposite to the nozzle surface 5, a chip plate 205 for supplying liquid is adhesively fixed with the mounting adhesive 401.

The physical property values are the same as in Examples 2 and 3, and the physical property values of other members are as follows. That is, the mounting adhesive 401 has a Young's modulus of 3.3 GPa, a linear expansion coefficient of 73×10^-6/K, a density of 1,200 kg/m^3, and a Poisson's ratio of 0.3. The face cover 204 is made of Kovar and has a Young's modulus of 159 GPa, a linear expansion coefficient of 5.2×10^-6/K, a density of 8,000 kg/m^3, and a Poisson's ratio of 0.3. The chip plate 205 is made of alumina and has a Young's modulus of 350GPa, a linear expansion coefficient of 7×10^-6/K, a density of 3,900 kg/m^3, and a Poisson's ratio of 0.23. The sealing agent 402 is CV5420DR and has a Young's modulus of 13 GPa, a linear expansion coefficient of 18×10^-6/K, a density of 1,800 kg/m^3, and a Poisson's ratio of 0.3.

The opening widths in the short-side direction of the respective configurations are 891 μm for the first common supply channel 13a and the first common collecting channel 13b, 266 μm for the second common channel 16, 500 μm for the damper chamber 301, and 206 μm for the common supply film opening 20a2 and the common collection film opening 20b. The first wall 30 and the second wall 31 are 125 μm, the slit groove 40 is 100 μm, and the slit opening 41 is 40 μm. The first common collecting channel 13b2 is 1,241 μm, and the cross-sectional configuration corresponds to when eight nozzle rows are arranged in the Y direction.

Corresponding to eight nozzle rows, the channel substrate 203 has the first common collecting channels 13b and 13b2 arranged at both ends in the Y direction, and the first common collecting channels 13b and the first common supply channels 13a are alternately arranged. The second channel forming substrate 304 has the second common collecting channel 16b arranged at the left end in the Y direction, the damper structure 302 at the right end, and the slit groove 40 further to the right thereof. The second channel forming substrate 304 has the second common collecting channels 16b, the second common supply channels 16a, the damper structures 302, and the common film openings 20 arranged in correspondence with the first common collecting channels 13b and the first common supply channels 13a.

The distance from the left end of the second common supply channel 16a at the left end in the Y direction to the end of the second channel forming substrate 304 is 1,000 μm, and the distance from the right end of the slit groove 40 at the right end in the Y direction to the end of the second channel forming substrate 304 is 1,100 μm. The width of the channel substrate 203 in the Y direction is 200 μm larger than the width of the second channel forming substrate 304, and the nozzle substrate 201 and the actuator substrate 202 are 1,200 μm larger than the width of the channel substrate 203 in the Y direction. The width of the chip plate 205 in the Y direction is 1,000 μm larger than the nozzle substrate 201, the width of the face cover 204 in the Y direction is 2,000 μm larger than the nozzle substrate 201, and the overlapping width of the bonding portion with the nozzle surface 5 is 1,000 μm.

The sizes in the Z direction of the respective configurations are 20 μm for the nozzle substrate 201, 90 μm for the actuator substrate 202, 200 μm for the first common channel 13, 425 μm for the second common channel 16, and 625 μm for the channel substrate 203 and the second channel forming substrate 304. The face cover 204 is 100 μm, the chip plate 205 is 1,000 μm, the mounting adhesive 401 is 10 μm, the sealing agent 402 is 425 μm, the adhesive 400 is 2 μm, and the flexible film 300 is 3 μm.

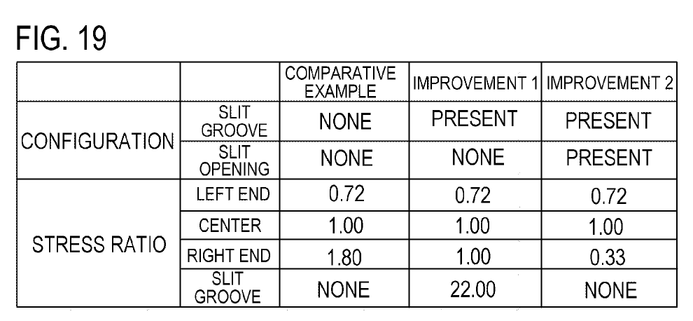

Configurations other than those described above are omitted. With the above configuration, the normal stress in the Z-axis direction generated in the flexible film 300 by differences in linear expansion coefficients was calculated, with the Z face on the outside in the Y direction of the face cover as a fixed end 50. The calculation results are shown in FIG. 19.

FIG. 19 shows the stress ratio of the normal stress in the Z direction generated between the flexible film 300 and the adhesive 400 in the respective configurations. In the configuration shown in FIG. 18, in which nine damper structures 302 are arranged in the Y direction, the stresses generated at the left end of the first damper structure 302, the center of the fifth damper structure 302, and the right end of the ninth damper structure 302 in the Y direction are shown. The stresses generated in the other damper structures 302 were equivalent to those generated at the center of the fifth damper structure 302, and are therefore omitted. In the comparative example in which the slit groove 40 and the slit opening 41 are not provided, the average value of the normal stress applied to the flexible film 300 of the central damper structure 302 is set to 1.0, and the average values of the normal stresses of the other calculation results are normalized.

In the comparative example, the stress ratio of the damper structure 302 at the right end is as large as 1.8, and it can be said that the flexible film 300 is prone to peeling. In the configuration of Improvement 1, in which only the slit groove 40 is provided, the stress ratio of the damper structure 302 at the right end is 1.0, and it can be said that the stress can be reduced to a value equivalent to that of the central damper structure 302, and the configuration can reduce peeling of the flexible film 300. In the configuration of Improvement 2, in which the slit groove 40 and the slit opening 41 are provided, the stress ratio of the damper structure 302 at the right end is 0.33, and the stress is further reduced, providing a configuration that can reduce peeling of the flexible film 300.

In the configuration of Improvement 1, although the stress applied to the flexible film 300 of the damper structure 302 can be reduced, since there is no slit opening 41, the stress ratio generated in the flexible film 300 at the slit groove 40 portion is 22, and there is a high possibility that peeling may occur at the slit groove 40 portion. Although this is not a functional problem since it is not the damper structure 302, there is a possibility that the peeled flexible film 300 may become debris and block the nozzle 3, or that the peeling at the slit groove 40 portion may become a starting point for peeling of the flexible film 300 of the adjacent damper structure 302. Therefore, the configuration of Improvement 2 in which the slit opening 41 is provided is used.

The opening portion of the slit opening 41 may have an opening area larger than the opening area of the nozzle 3 when viewed from the XY plane, as with the common film opening 20, so that the flexible film 300 is present so as to partially cover the slit groove 40.

Further, in the present example, the slit groove 40 and the slit opening 41 are provided at the right end in the Y direction, but depending on the size and configuration of the liquid ejection substrate 2, similar slit grooves 40 and slit openings 41 may be provided at the left end or both ends in the Y direction, or at one end or both ends in the X direction. In particular, since stress increases at locations near portions where the bonding area of the adhesive 400 or mounting adhesive 401 is large, or at locations where the structure is asymmetric, the slit groove 40 and the slit opening 41 may be provided at locations where the bonding area is large or where the structure is asymmetric.

By adopting a configuration such as that of the present example, even in a form such as the liquid ejection head module 1, stress applied to the flexible film 300 can be reduced and peeling of the flexible film 300 can be suppressed.

### Example 5

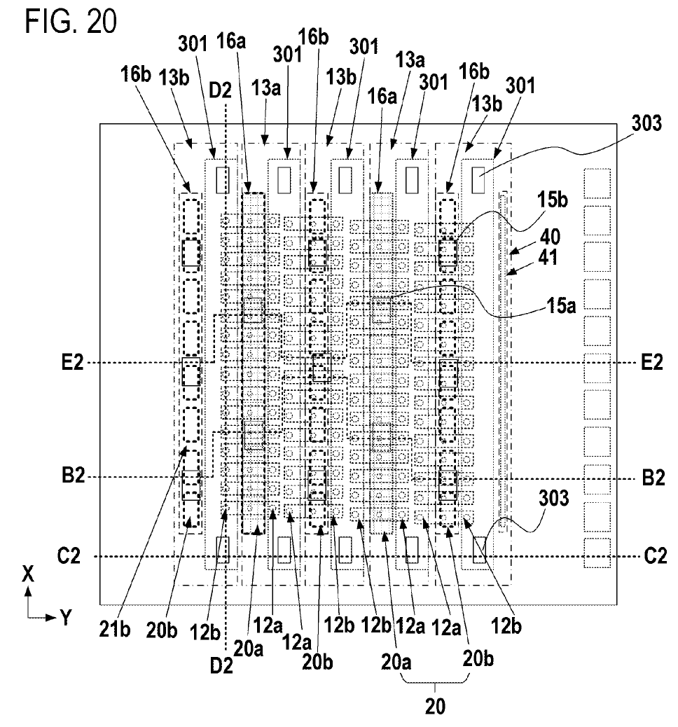

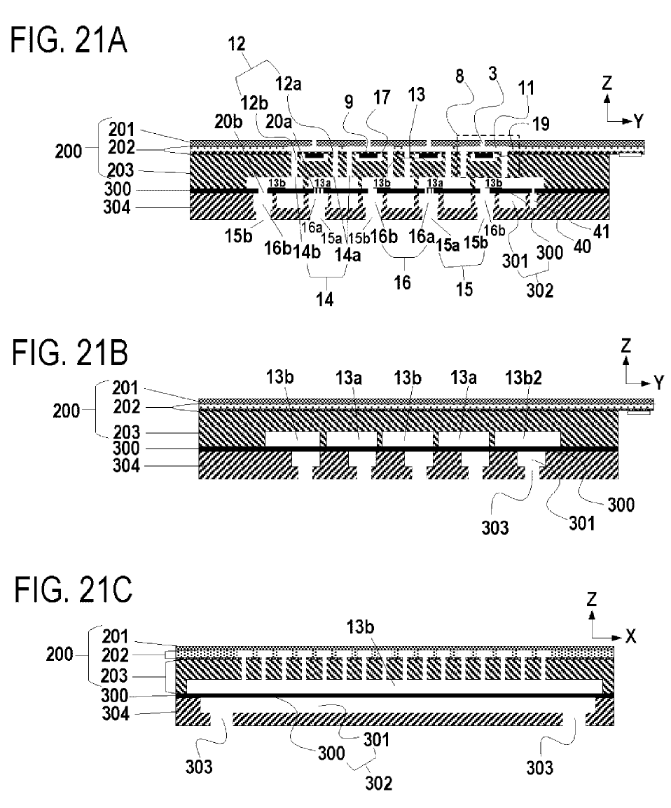

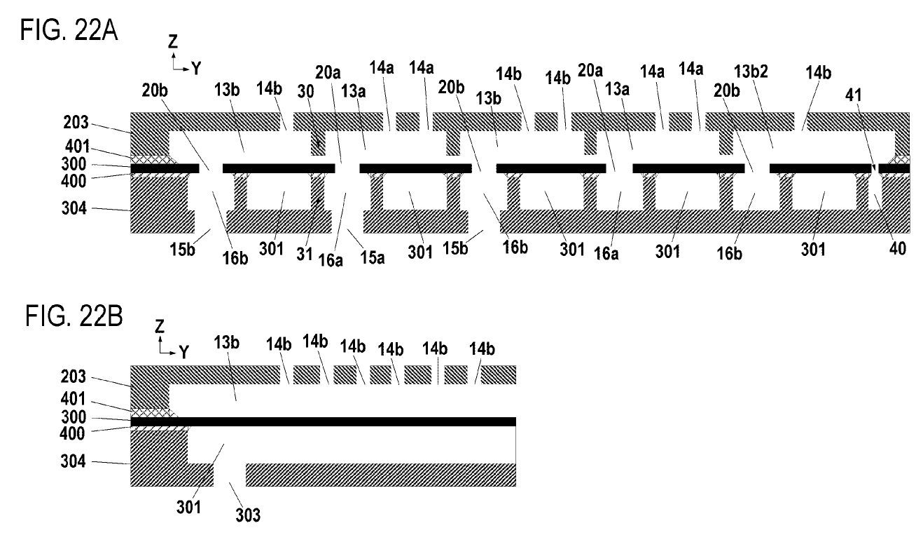

One example of the relationship among the first common channel 13, the second common channel 16, and the damper chambers 301 will be described with reference to FIG. 20. FIG. 20 is a plan perspective view showing an enlarged partial view of the liquid ejection substrate 2. FIG. 21A is a cross-sectional view taken along line B2-B2 of FIG. 20. FIG. 21B is a cross-sectional view taken along line C2-C2 of FIG. 20. FIG. 21C is a cross-sectional view taken along line D2-D2 of FIG. 20. FIG. 22A is a cross-sectional view showing an enlargement of FIG. 21A with the nozzle substrate 201 and the actuator substrate 202 omitted. FIG. 22B is a cross-sectional view showing an enlargement of an end portion of FIG. 21C with the nozzle substrate 201 and the actuator substrate 202 omitted.

As shown in FIGS. 20-22A and 22B, the first common channels 13 surround the second common channels 16 and the damper chambers 301. That is, both ends of the first common channels 13 in the Y direction are located further outward than the second common channels 16 and the damper chambers 301. More specifically, the first common supply channels 13a and the first common collecting channels 13b are each provided in plurality so as to be alternately aligned with each other in the Y direction, and on both sides in the same direction, the first common collecting channels 13b are arranged further outward than the first common supply channels 13a. The outermost end portions in the Y direction of the first common collecting channels 13b arranged at the outermost positions in the Y direction are located further outward in the Y direction than any of the second common supply channels 16a, the second common collecting channels 16b, the damper chambers 301, and the slit grooves 40 that are arranged in the Y direction. With such a configuration, the adverse influence of the overflowing portions of the mounting adhesive 401 generated when the flexible film 300 is adhesively fixed between the first channel forming substrate 200 and the second channel forming substrate 304, wetting and spreading over the flexible film 300 of the damper structure 302 and thereby impairing its damping function, can be reduced. The states of overflow of the mounting adhesive 401 and the adhesive 400 are shown in FIGS. 22A and 22B.

By adopting a configuration such as that of the present disclosure as described above, even in a form such as the liquid ejection head module 1, a configuration of the liquid ejection head can be obtained that can reduce stress applied to the flexible film 300 to suppress peeling of the flexible film 300, and can suppress peeling of the damper film while maintaining ink circulation.

### Example 6

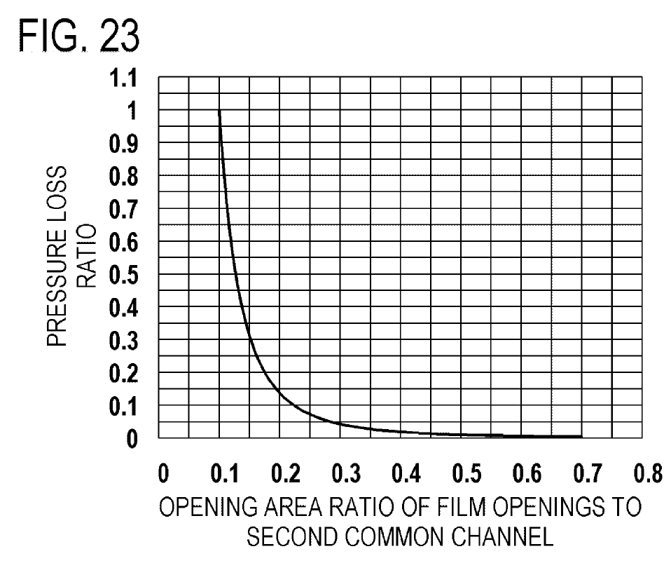

The opening ratio of the common film opening 20 will be described with reference to FIG. 23. The horizontal axis of FIG. 23 represents the ratio of the opening area of the common film opening 20 to the XY-plane opening area of the second common channel 16, that is, the opening area of the common film opening 20 ÷ the XY-plane opening area of the second common channel 16. Here, the XY-plane opening area of the second common channel 16 is the total opening area obtained by adding together all the opening areas perpendicular to the Z direction of the plurality of second common supply channels 16a and the plurality of second common collecting channels 16b. Similarly, the opening area of the common film opening 20 is the total opening area obtained by adding together all the opening areas perpendicular to the Z direction of the plurality of supply openings 20a and the plurality of collection openings 20b. The vertical axis represents the pressure loss when passing through the common film opening 20 from the XY-plane opening side of the second common channel 16, expressed as a ratio where the pressure loss at an opening ratio of 0.1 on the horizontal axis is set to 1.

As can be seen from FIG. 23, since the change in pressure loss becomes small around an opening ratio of 0.2 on the horizontal axis, the opening ratio of the common supply film openings and the common collection film openings is 0.2 or more. Furthermore, the opening ratio is 0.3 or more, since the pressure loss can be reduced to 0.05 or less.

The common film openings 20 may be arranged in any shape and pitch to achieve the desired opening ratio, and common film openings of different shapes and pitches may be formed within the same second common channel. Further, in the present example, a configuration for supplying and recovering liquid and circulating it was shown, but the present disclosure can also be applied to a configuration that only supplies liquid without circulation, and the same effect can be obtained.

### Example 7

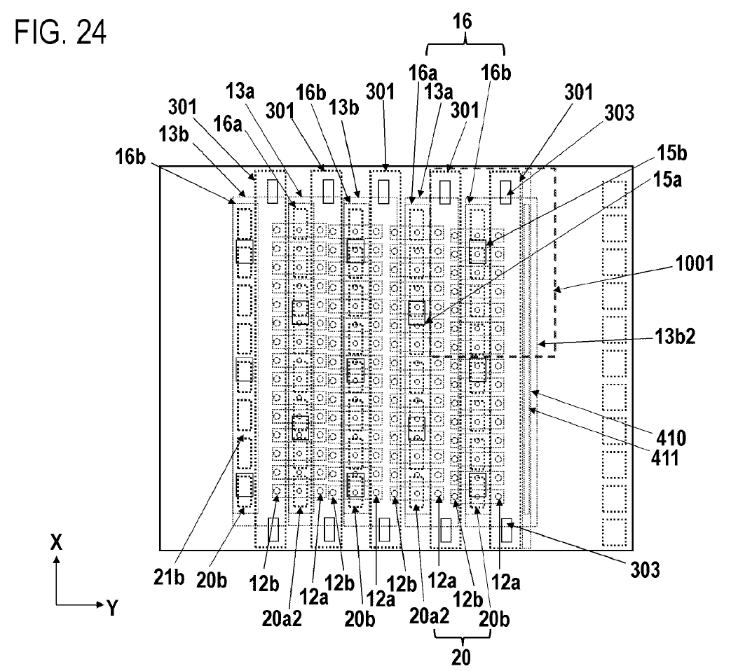

Another configuration example for further reducing stress applied to the flexible film 300 will be described with reference to FIGS. 24-26A and 26B.

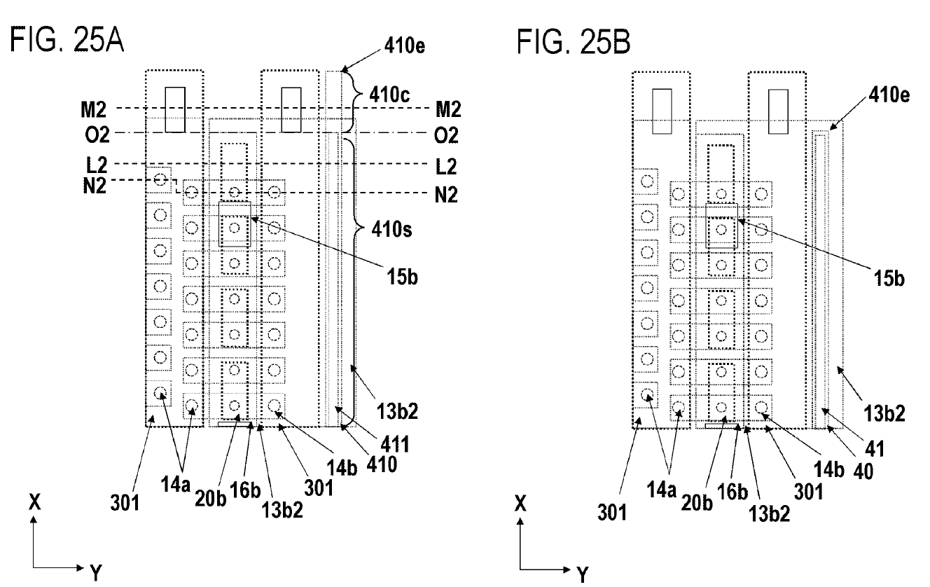

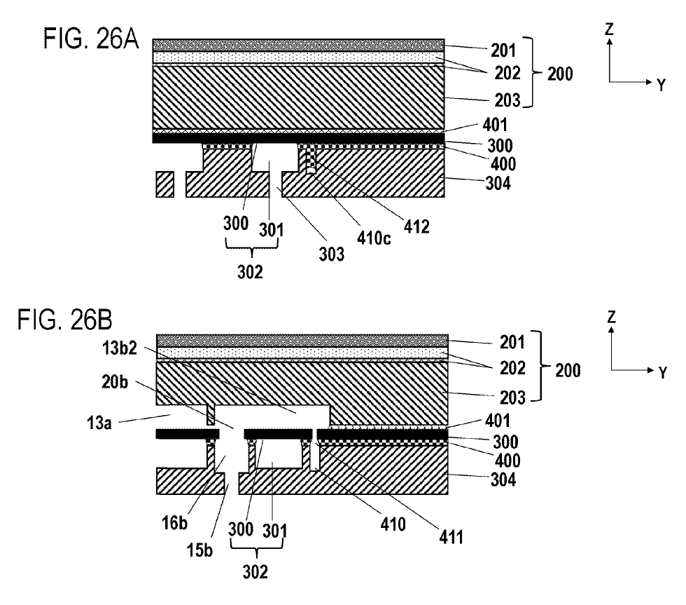

FIG. 24 is an XY-plane view of a configuration in which slit grooves 410 and slit openings 411 are provided in the second channel forming substrate 304 and the flexible film 300. FIG. 25A is an enlarged view of a region 1001 in FIG. 24. FIG. 25B is a diagram showing a comparative example of the present example. FIG. 26A shows a cross-section taken along line M2-M2 of FIGS. 25A, and 26B shows a cross-section taken along line L2-L2.

As shown in FIGS. 24 and 25A, the second channel forming substrate 304 is formed with the second common channels 16 (second common supply channel 16a, second common collecting channel 16b) and the damper chambers 301. These are arranged in the order of the second common collecting channel 16b, the damper chamber 301, the second common supply channel 16a, and the damper chamber 301 along the Y direction. As shown in FIGS. 26A and 26B, the flexible film 300 is fixed between the second channel forming substrate 304 and the first channel forming substrate 200 along the Z direction by the adhesive 400 and the mounting adhesive 401.

Further, slit grooves 410 and slit openings 411 for relieving stress applied to the flexible film 300 are formed at the portions adjacent to the damper chamber 301 located at the terminal end in the Y direction, that is, on the outside of the damper chamber 301 in the Y direction in FIGS. 24 and 25A.

As shown in FIG. 24, when viewed from the Z direction, the slit groove 410 has a structure in which both end portions in the X direction are enclosed on three sides, whereas the lateral portions are enclosed on two sides. That is, both end portions of the slit groove 410 in the X direction have a structure surrounded by two opposing wall surfaces corresponding to two sides extending parallel along the X direction and one wall surface corresponding to one side extending along the Y direction. In contrast, the lateral portions, which are portions of the slit groove 410 other than both end portions in the X direction, have a structure sandwiched from two directions of the +Y direction and −Y direction by two opposing wall surfaces corresponding to two sides extending parallel along the X direction, with the X direction being open. For this reason, the adhesive 400 tends to concentrate at both end portions of the slit groove 410 in the X direction during bonding, and tends to overflow into the slit groove 410 and be filled and stored therein. FIG. 25A shows the configuration around an end portion 410e of the slit groove 410, which is one end of the slit groove 410 in the X direction. One example of the state of an overflow portion 412 of the adhesive 400 that has overflowed into the end portion 410e of the slit groove 410 is shown in FIG. 26A. The cross-section taken along line M2-M2 of FIG. 25A shown in FIG. 26A is a cross-section intersecting the vicinity of the end portion 410e of the slit groove 410 in the X direction. When the adhesive 400 fills both end portions of the slit groove 410 in the X direction, the stress caused by the difference in linear expansion coefficients of the materials that were originally divided by the slit groove 410 results in a continuous structure through the filling with the adhesive 400, and the materials are no longer divided. As a result, stress is applied to the flexible film 300, raising concern that film peeling may occur.

To address this problem, in the present example, as shown in FIGS. 25A, 26A, and 26B, the slit groove 410 is formed by extending it on both sides in the X direction. FIG. 25B shows the configuration of a comparative example in which the slit groove 410 is not extended on both sides in the X direction, with the position of the end portion 410e of the slit groove 410 in the X direction being substantially the same as the X-direction terminal end position of the second common collecting channel 16b. In contrast, in the present example, the position in the X direction of one end portion 410e of the extended slit groove 410 is configured to extend beyond the X-direction terminal end position in the +X direction of the second common collecting channel 16b indicated by the dash-dot line O2-O2 in FIG. 25A. With regard to the −X direction, the other end portion of the slit groove 410 is configured to protrude beyond the −X-direction terminal end position of the second common collecting channel 16b in the −X direction. Stress applied to the flexible film 300 tends to concentrate at the bonded portion between the second common collecting channel 16b and the damper chamber 301, and the main component of the stress acts in the Y direction. For this reason, the stress-dividing effect can be maintained by forming the overflow portions 412 of the adhesive 400 inside the vicinities of both end portions of the slit groove 410 located at positions farther in the X direction from the dash-dot line O2-O2.

It can be expected that forming the slit opening 411 with the opening end in the X direction extending beyond the position indicated by the dash-dot line O2-O2 in the X direction will further enhance the maintainability of the stress-dividing effect. However, in order to suppress detachment of the adhesive 400 stored in the slit groove 410, the position of the opening end of the slit opening 411 in the X direction is the position indicated by the dash-dot line O2-O2.

As a result, as shown in FIG. 25A, the portion of the slit groove 410 away from the X-direction terminal end position of the second common collecting channel 16b in the X direction (the vicinity of the end portion 410e) becomes a covered region 410c covered by the flexible film 300. As shown in FIG. 26A, in the covered regions 410c covered by the flexible film 300 at both end portions of the slit groove 410 in the X direction, the adhesive 400 accumulates without detaching, forming overflow portions 412 of the adhesive 400. On the other hand, in the portion 410s (the above-described lateral portions) of the slit groove 410 shown in FIG. 26B where the position in the X direction overlaps with the second common collecting channel 16b, the configuration is such that adhesive does not accumulate, and the maintainability of the stress-dividing effect on the flexible film 300 is improved.

In the present example, by extending the slit groove 410 in the long-side direction, the region filled with the adhesive 400 can be moved away from the short-side direction where stress tends to concentrate. This reduces the influence of stress applied to the flexible film 300, and the effect of suppressing film peeling is obtained.

### Example 8

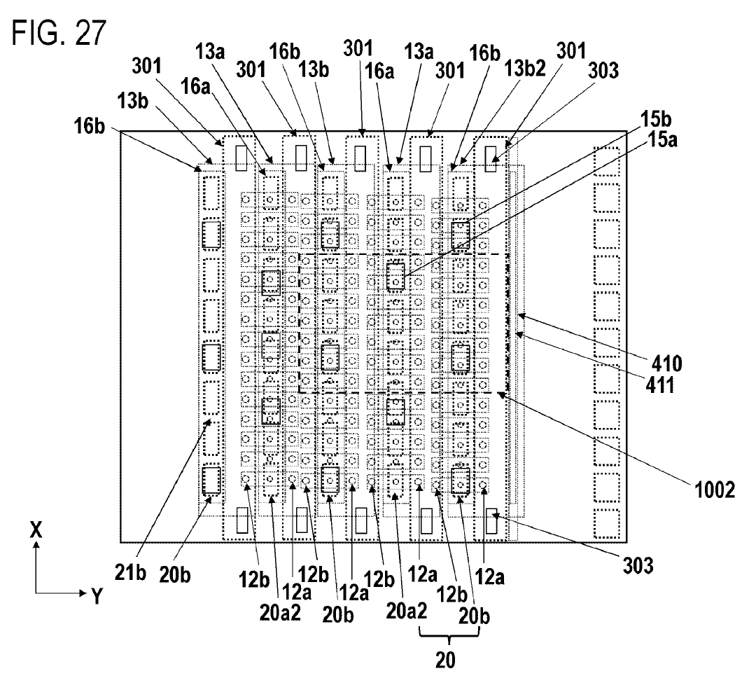

Another configuration example for further reducing stress applied to the flexible film 300 will be described with reference to FIGS. 27-29A-29C.

FIG. 27 is an XY-plane view of a configuration in which slit grooves 410 and slit openings 411 are provided in the second channel forming substrate 304 and the flexible film 300.

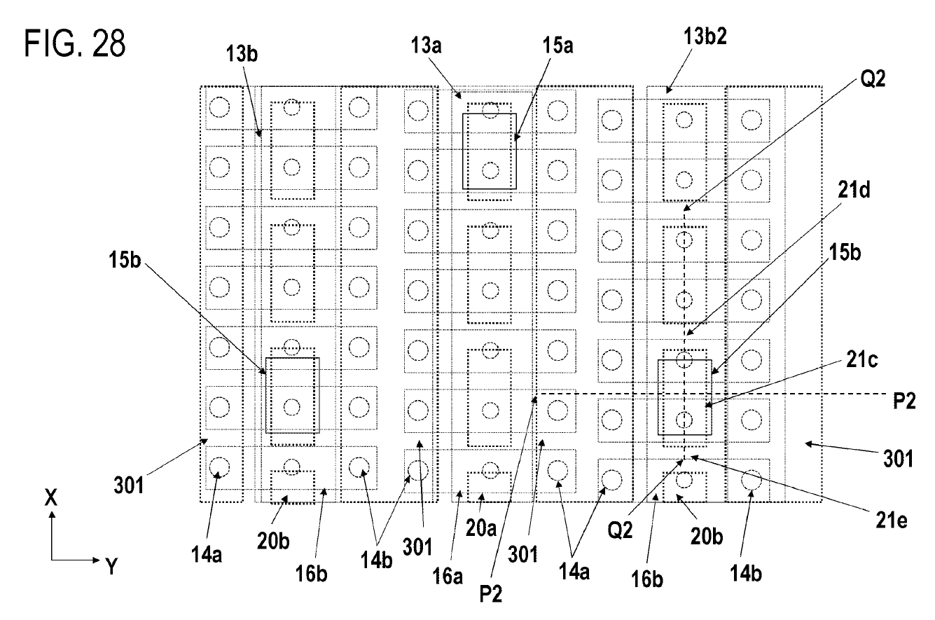

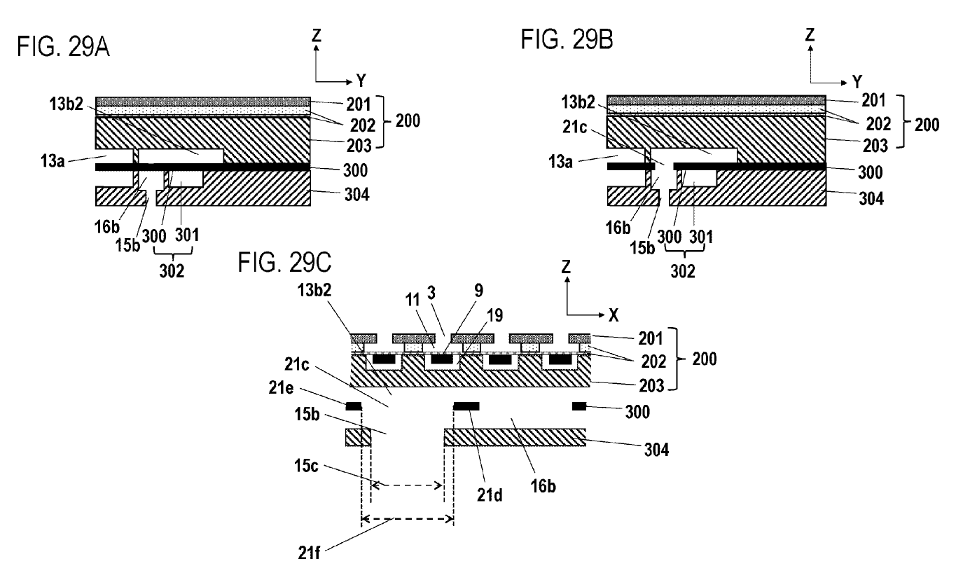

FIG. 28 is an enlarged view of a region 1002 in FIGS. 27, 29B shows the configuration of the present example and shows a cross-section taken along line P2-P2 of FIG. 28. FIG. 29C shows the configuration of the present example and shows a cross-section taken along line Q2-Q2 of FIG. 28. FIG. 29A shows a cross-sectional view of a comparative example with respect to the present example.

As shown in FIGS. 27 and 28, the second channel forming substrate 304 is formed with the second common channels 16 (second common supply channel 16a, second common collecting channel 16b) and the damper chambers 301. These are arranged in the order of the second common collecting channel 16b, the damper chamber 301, the second common supply channel 16a, and the damper chamber 301 along the Y direction. In a region of the flexible film 300 corresponding to the second common channel 16, openings 21c penetrating the flexible film 300 in the Z direction are formed. The openings 21c are formed in plurality at predetermined intervals in the X direction. Regions of the flexible film 300 between the plurality of openings 21c aligned in the X direction serve as bridging portions 21d and 21e that connect a region on one side in the Y direction and a region on the other side in the Y direction with respect to the row of openings 21c. That is, in the X direction, the plurality of openings 21c and the plurality of bridging portions are alternately arranged, and the bridging portions 21d and 21e are examples of two bridging portions adjacent in the X direction among the plurality of bridging portions.

Ink is supplied from the common supply through-holes 15a, passes through the second common supply channel 16a, and passes through the supply film openings 20a of the flexible film 300. Alternatively, the configuration is such that ink that has passed through the collection film openings 20b of the flexible film 300 passes through the second common collecting channel 16b and is recovered to the outside of the liquid ejection substrate 2 via the common collecting through-holes 15b. In the present example, the positional relationship in the Z direction between the film openings and the common through-holes on the ink supply side is the same as the positional relationship in the Z direction between the film openings and the common through-holes on the ink collection side. Therefore, in the following description, the configuration on the ink collection side is taken as an example, and one of the plurality of collection film openings 20b will be described as the opening 21c.

In this case, as shown in FIG. 29A, if the configuration is such that the flexible film 300 partially shields directly above the common collecting through-holes 15b in the Z direction, there is concern that the ink fluid may directly collide with the flexible film 300, generating bending stress in the flexible film 300 and causing film peeling. This is particularly pronounced in the second common supply channel 16a.

To address this problem, as shown in FIG. 29B, a configuration is adopted in which the flexible film 300 shields as little as possible directly above the common supply through-holes 15a and the common collecting through-holes 15b in the Z direction. Specifically, a configuration is adopted in which the bridging portions 21d and 21e of the flexible film 300 do not overlap with the common supply through-holes 15a and the common collecting through-holes 15b when viewed in the Z direction. That is, as the configuration on the supply side, the bridging portions 21d and 21e as the plurality of first bridging portions are arranged at positions that do not overlap with the common supply through-holes 15a when viewed in the Z direction. Similarly, as the configuration on the collecting side, the bridging portions 21d and 21e as the plurality of second bridging portions are arranged at positions that do not overlap with the common collecting through-holes 15b when viewed in the Z direction. Furthermore, the opening area of the openings 21c of the flexible film 300 is configured to be larger than the opening areas of the common supply through-holes 15a and the common collecting through-holes 15b. Furthermore, it is preferable that, in the Y direction, the width of the openings 21c of the flexible film 300 be wider than the widths of the common supply through-holes 15a and the common collecting through-holes 15b, and that the common supply through-holes 15a and the common collecting through-holes 15b be located further inward than both ends of the openings 21c. Furthermore, as shown in FIG. 29C, the bridging portions 21d and 21e are arranged in the X direction such that the end portions of the bridging portions 21d and 21e are separated from the end portions of the common collecting through-holes 15b. That is, the bridging portion 21dis located on the outside in the X direction with respect to one end portion of the common collecting through-holes 15b in the X direction, and the bridging portion 21e is also located on the outside in the X direction with respect to the other end portion of the common collecting through-holes 15b in the X direction. Note that FIGS. 29B and 29C illustrate only the positional relationship between the common collecting through-holes 15b and the bridging portions 21d and 21e, but the positional relationship between the common supply through-holes 15a and the bridging portions 21d and 21e is configured similarly.

Further, when the ink fluid flows out from the common supply through-holes 15a into the second common supply channel 16a, it flows out so as to spread while forming a skirt portion beyond the opening region of the common supply through-holes 15a. Further, when flowing into the common collecting through-holes 15b from the second common collecting channel 16b, a similar skirt portion is formed, so that the region in which bending stress is generated in the flexible film 300 is approximately twice the opening region of the common supply through-holes 15a and the common collecting through-holes 15b. For this reason, as shown in FIG. 29C, the distance (interval) 21f in the X direction between the bridging portion 21d and the bridging portion 21e that are adjacent in the X direction among the plurality of bridging portions is made longer than the opening width 15c in the X direction of the common supply through-holes 15a and the common collecting through-holes 15b. It is more preferable that the distance 21fbe at least twice the opening width 15c.

This reduces bending stress applied to the flexible film 300 and suppresses film peeling due to collision of ink fluid, thereby providing the effect of improving the reliability and durability of the ejection head.

The above examples can be combined with each other.

According to the present disclosure, stabilization of liquid circulation and stabilization of a damper structure can be achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-076411, filed on May 1, 2025, and No. 2026-022312, filed on Feb. 13, 2026, which are hereby incorporated by reference herein in their entirety.

What is claimed is:

1. A liquid ejection head, comprising:
a first substrate including a plurality of pressure chambers, a first common supply channel, and a first common collecting channel, the plurality of pressure chambers each being provided with an ejection port that opens in a first direction and a pressure generating unit for generating pressure to eject liquid from the ejection port, the first common supply channel being a channel for supplying liquid to each of the plurality of pressure chambers, the first common collecting channel being a channel for collecting liquid from each of the plurality of pressure chambers;
a second substrate laminated on the first substrate in the first direction, the second substrate including a second common supply channel, a second common collecting channel, and a recessed portion, the second common supply channel being a channel for supplying liquid to the first common supply channel, the second common collecting channel being a channel for collecting liquid from the first common collecting channel, the recessed portion being recessed in the first direction and provided in each of a region facing the first common supply channel and a region facing the first common collecting channel; and
a flexible film provided between the first substrate and the second substrate, the flexible film having a supply opening, a collection opening, and a film portion, the supply opening being an opening that penetrates the flexible film in the first direction and causes the first common supply channel and the second common supply channel to communicate with each other, the collection opening being an opening that penetrates the flexible film in the first direction and causes the first common collecting channel and the second common collecting channel to communicate with each other, the film portion covering the recessed portion to form a damper chamber,
wherein an opening area of the collection opening perpendicular to the first direction is larger than an opening area of the ejection port.

2. The liquid ejection head according to claim 1,
wherein the supply opening is composed of a plurality of communication holes each having the same opening area, which is smaller than the opening area of the ejection port.

3. The liquid ejection head according to claim 1,
wherein the opening area of the collection opening is equivalent to the opening area of the second common collecting channel.

4. The liquid ejection head according to claim 1,
wherein a width of the collection opening in a second direction orthogonal to the first direction is equivalent to a width of the second common collecting channel in the second direction, and
wherein the collection opening is provided as a plurality divided in a third direction orthogonal to both the first direction and the second direction.

5. The liquid ejection head according to claim 1,
wherein the first common supply channels and the first common collecting channels are each provided in plurality so as to be alternately aligned with each other in a second direction orthogonal to the first direction,
wherein the second common supply channels and the second common collecting channels are each provided in plurality so as to be alternately aligned with each other in the second direction,
wherein the collection opening includes:
a first collection opening that causes the first common collecting channel, which is adjacent to the first common supply channel on one side in the second direction, to communicate with the second common collecting channel, which is adjacent to the second common supply channel on one side; and
a second collection opening that causes the first common collecting channel, which is adjacent to the first common supply channel on the other side in the second direction, to communicate with the second common collecting channel, which is adjacent to the second common supply channel on the other side,
wherein a width of the first collection opening in the second direction is wider than a width of the supply opening in the second direction, and
wherein a width of the second collection opening in the second direction is narrower than a width of the supply opening in the second direction.

6. The liquid ejection head according to claim 5,
wherein a width of the first collection opening in the second direction is wider than a width of the second common collecting channel, with which the first collection opening causes the first common collecting channel to communicate, in the second direction.

7. The liquid ejection head according to claim 5,
wherein a width of the second collection opening in the second direction is narrower than a width of the second common collecting channel, with which the second collection opening causes the first common collecting channel to communicate, in the second direction.

8. The liquid ejection head according to claim 5,
wherein the second collection opening is closer to an end portion of the flexible film than the first collection opening in the second direction.

9. The liquid ejection head according to claim 1,
wherein the second substrate further includes a plurality of common supply through-holes for supplying liquid to the second common supply channel and a plurality of common collecting through-holes for collecting liquid from the second common collecting channel,
wherein the supply opening and the collection opening are each provided as a plurality divided in a third direction orthogonal to both the first direction and a second direction orthogonal to the first direction,
wherein the flexible film includes:
a plurality of first bridging portions that, with respect to a row of a plurality of supply openings arranged in the third direction, connect a region on one side in the second direction and a region on the other side in the second direction between the plurality of supply openings; and
a plurality of second bridging portions that, with respect to a row of a plurality of collection openings arranged in the third direction, connect a region on one side in the second direction and a region on the other side in the second direction between the plurality of collection openings;
wherein the first bridging portions are provided at positions that do not overlap with the common supply through-holes in a case of viewing in the first direction, and
wherein the second bridging portions are provided at positions that do not overlap with the common collecting through-holes in a case of viewing in the first direction.

10. The liquid ejection head according to claim 9,
wherein an opening area of the supply openings is larger than an opening area of the common supply through-holes, and
wherein an opening area of the collection openings is larger than an opening area of the common collecting through-holes.

11. The liquid ejection head according to claim 9,
wherein the first bridging portions are located at positions separated from the common supply through-holes in the third direction, and
wherein the second bridging portions are located at positions separated from the common collecting through-holes in the third direction.

12. The liquid ejection head according to claim 9,
wherein an opening width of the supply openings in the third direction is wider than a width of the common supply through-holes in the third direction, and
wherein an opening width of the collection openings in the third direction is wider than a width of the common collecting through-holes in the third direction.

13. The liquid ejection head according to claim 1,
wherein the first common supply channels and the first common collecting channels are each provided in plurality so as to be alternately aligned with each other in a second direction orthogonal to the first direction, and on both sides in the second direction, the first common collecting channels are arranged further outward than the first common supply channels, and
wherein the second substrate is provided with a slit groove in a region that is outside the outermost damper chamber on one side in the second direction and that faces the first common collecting channel arranged at the outermost position on the one side in the second direction, the slit groove being recessed in the first direction and extending in a third direction orthogonal to both the first direction and the second direction.

14. The liquid ejection head according to claim 13,
wherein the flexible film has a slit opening that causes the slit groove to communicate with the first common collecting channel facing the slit groove.

15. The liquid ejection head according to claim 13,
wherein a length of the slit groove in the third direction is longer than a length of the second common supply channel and the second common collecting channel in the third direction.

16. The liquid ejection head according to claim 15,
wherein the slit groove has a covered region covered by the flexible film on the outside of the second common supply channel and the second common collecting channel in the third direction.

17. The liquid ejection head according to claim 16,
wherein, in the covered region, an adhesive is stored in the slit groove.

18. The liquid ejection head according to claim 14,
wherein an opening area of the slit opening perpendicular to the first direction is larger than the opening area of the ejection port.

19. The liquid ejection head according to claim 13,
wherein the first common supply channels and the first common collecting channels are each provided in plurality so as to be alternately aligned with each other in a second direction orthogonal to the first direction, and on both sides in the second direction, the first common collecting channels are arranged further outward than the first common supply channels, and
wherein the outermost end portions in the second direction of the first common collecting channels arranged at the outermost positions in the second direction are each located further outward in the second direction than any of the second common supply channels, the second common collecting channels, the damper chambers, and the slit grooves that are arranged in the second direction.

20. The liquid ejection head according to claim 1,
wherein the liquid ejection head includes a plurality of each of the first common supply channels, the first common collecting channels, the second common supply channels, the second common collecting channels, the supply openings, and the collection openings, and
wherein a ratio of a total opening area perpendicular to the first direction of the plurality of supply openings and the plurality of collection openings to a total opening area perpendicular to the first direction of the plurality of second common supply channels and the plurality of second common collecting channels is 0.2 or more.
